(19) United States
(12) Patent Application Publication
(10) Pub. No.: US 2012/0217399 A1
(43) Pub. Date: Aug. 30, 2012

(54) Ultra Broad Spectral Band Detection

(76) Inventor: Araz Yacoubian, Carlsbad, CA (US)

(21) Appl. No.: 13/405,115

(22) Filed: Feb. 24, 2012

Related U.S. Application Data
(60) Provisional application No. 61/446,457, filed on Feb. 24, 2011.

(51) Int. Cl. G01J 1/00; G01J 5/00

(52) U.S. Cl. 250/338.1; 250/336.1

(57) ABSTRACT

An embodiment of a sensing apparatus can comprise a sensor and a controller. The sensor can be configured to detect broadband electromagnetic (EM) radiation and generate electrical signals in response to the detected broadband EM radiation. The controller is coupled to the sensor and configured to receive the electrical signals and process the electrical signals to segment the sensor response to broadband EM radiation into a plurality of digitized pixels.

### BACKGROUND

Detection of broadband electromagnetic (EM) radiation such as visible, infrared, ultra-violet (UV) radiation, as well as radiation in other parts of the EM spectrum, has great interest in many technology areas. Many current technologies enable detection and imaging only in a narrow part of the EM spectrum, such as visible only, infra-red only, or UV.

Many conventional detection technologies utilize sensing of electronic transition between various states of atoms, excited by the incoming EM radiation, and are therefore limited to a narrow part of the EM spectrum

### SUMMARY

An embodiment of a sensing apparatus can comprise a sensor and a controller. The sensor can be configured to detect broadband electromagnetic (EM) radiation and generate electrical signals in response to the detected broadband EM radiation. The controller is coupled to the sensor and configured to receive the electrical signals and process the electrical signals to segment the sensor response to broadband EM radiation into a plurality of digitized pixels.

### BRIEF DESCRIPTION OF THE DRAWINGS

Embodiments of the invention relating to both structure and method of operation may best be understood by referring to the following description and accompanying drawings:

FIGS. 1A and 1B are perspective pictorial and block diagrams illustrating an embodiment of a sensor configured as a one-dimensional scanning sensor apparatus;

FIG. 1C is a schematic block diagram illustrating an imaging apparatus that uses an image detection scheme to generate high-resolution broad spectral band images from a coarse detector array;

FIGS. 2A, 2B, 2C, 2D, 2E, 2F, and 2G are pictorial diagrams depicting embodiments of two-dimensional scanning sensor architectures;

FIGS. 3A, 3B, 3C, and 3D are pictorial diagrams showing side views of device embodiments with various cross-sectional forms;

FIG. 3E is a perspective pictorial and block diagram depicting an embodiment of a sensor configured for one-dimensional photo-acoustic imaging of broadband electromagnetic radiation;

FIGS. 4A, 4B, and 4C are combined pictorial and circuit diagrams that depict sensors which execute time-based detection of pulsed or modulated incident EM radiation;

FIGS. 5A and 5B are pictorial and graphic diagrams illustrating operation of an embodiment of a four-element sensor that produces time data from all four channels;

FIG. 6A is a schematic pictorial and circuit diagram depicting a sensor that executes detection using a chopper or modulator;

FIGS. 6B and 6C are perspective pictorial and block diagrams depicting embodiments of sensors configured for two-dimensional photo-acoustic imaging of broadband electromagnetic radiation;

FIG. 7 is a schematic pictorial and circuit diagram showing a sensor configuration that performs detection of static EM radiation (DC) using an electrical switching circuit;

FIGS. 8A and 8B are, respectively, a graph showing pixel calibration data in which signal amplitude is depicted as a function of scan distance, and an illumination pattern;

FIG. 9 is a schematic graph depicting an example of frequency response change with respect to distance between illuminated area and the sensing pixel;

FIGS. 10A, 10B, and 10C are pictorial graphic diagrams showing examples of triangulation or trilateration using distance measurement from time delay or frequency response method for locating illumination spot for usage by embodiments of sensor devices;

FIG. 11 is a blackbody radiation plot showing an example of blackbody radiation emission for an embodiment of a sensor that performs extreme temperature and radiation sensing;

FIG. 12 is a pictorial diagram depicting components that can be used for wavelength filtering;

FIG. 13 is a schematic block diagram that depicts a sensing apparatus that includes a spectrometer to perform spectroscopic sensing and surface and blackbody temperature detection;

FIG. 14 is a pictorial and block diagram of a sensing configuration and a signal waveform which depicts a method of generating two-dimensional image data using multi-layer device;

FIGS. 15A and 15B are pictorial and block diagrams of sensing configurations and associated signal waveforms showing double switching devices to be used with the broadband sensors;

FIGS. 16A, 16B, 16C, and 16D are perspective pictorial and block diagrams illustrating embodiments of sensors configured for detection or imaging of broadband electromagnetic radiation;

FIG. 17 is a perspective pictorial and block diagram showing an embodiment of a sensor configured for single element, one-dimensional or two-dimensional photo-acoustic imaging of broadband electromagnetic radiation; and

FIGS. 18A and 18B are schematic flow charts showing an embodiment or embodiments of a method for a broad spectral imaging sensor that enables reduction of sensing electrodes;

FIGS. 19A, 19B, 19C, and 19D are cross-sectional cut-away pictorial views showing embodiments of structures for spatial sampling of a broadband EM image; and

FIGS. 20A and 20B are cross-sectional cut-away pictorial views showing embodiments of structures for spatial sampling of a broadband EM image.

### DETAILED DESCRIPTION

In various embodiments of devices and associated methods, broadband electromagnetic (EM) radiation such as visible, infrared, ultra-violet (UV) radiation, as well as radiation in other parts of the EM spectrum, can be sensed and used for imaging. Various ultra-broad spectral band detection methods can be used for imaging, and for temperature measurement. Example applications and embodiments can sense and use incident radiation, electro-magnetic radiation, or incident photons interchangeably.

Broad spectral imaging can be performed using an M×N pixel device.

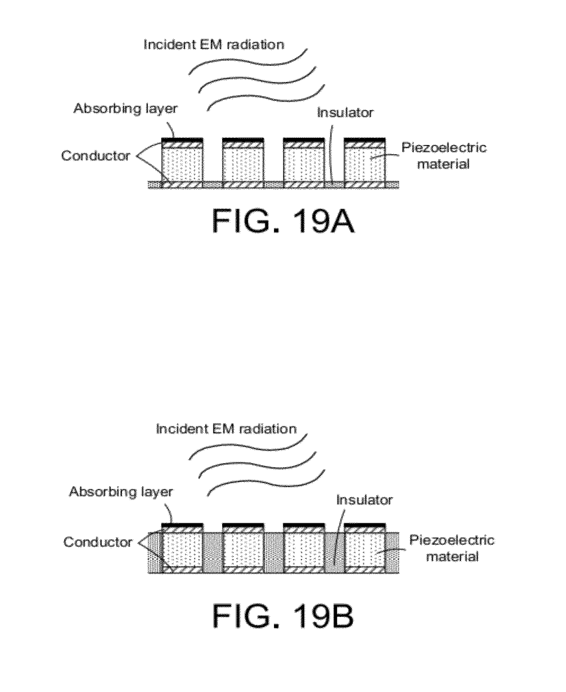

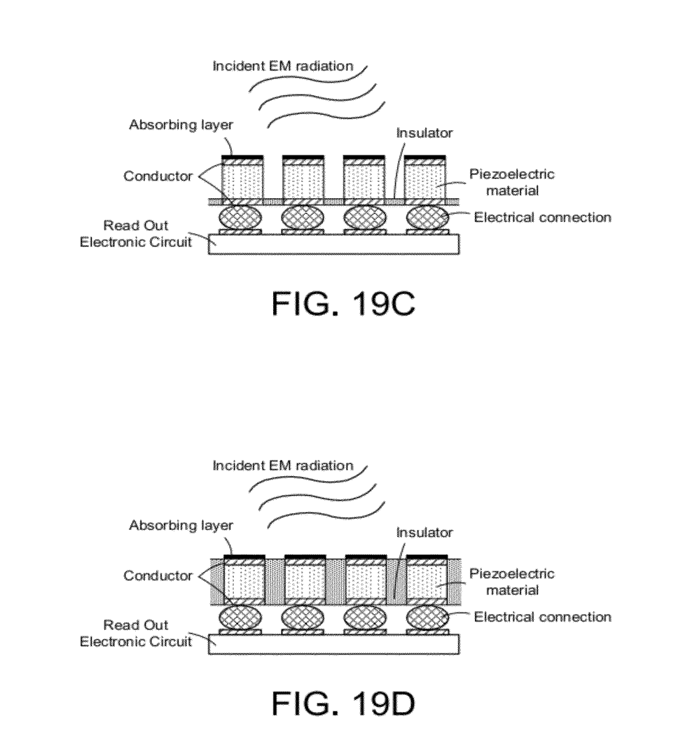

For example, various sensor configurations can be implemented using pixel structures. Various methods and apparatus using pixels to produce one-dimensional and two-dimensional images of the incident EM radiation are depicted in FIGS. 19A, 19B, 19C, and 19D. The illustrative structures and devices enable improved functionality by reducing cross-talk and avoiding resolution loss due to thermal conductivity and acoustic coupling between adjacent pixels. The improvement is achieved by incorporating thermal and acoustic insulating materials in the pixel structures.

A highly useful sensor configuration for imaging is a fine-pitch sensor array. Typically, for fine resolution imaging, a large number of pixels are fabricated using numerous electrodes. One difficulty of such a fine-pitch sensor array is the impracticality of individually amplifying and digitizing each electrode, which correspond to an individual pixel. Embodiments of a sensing apparatus can address this difficulty by using a limited number of electrodes and processing the signals from the limited number of electrodes to form a far larger number of pixels. Thus, individual electrodes are time-activated in a predetermined sequence and serial data is digitized to form a large number of pixels. The electrodes can be attached to a controller such as a read-out integrated circuit (ROIC) and using a shift register.

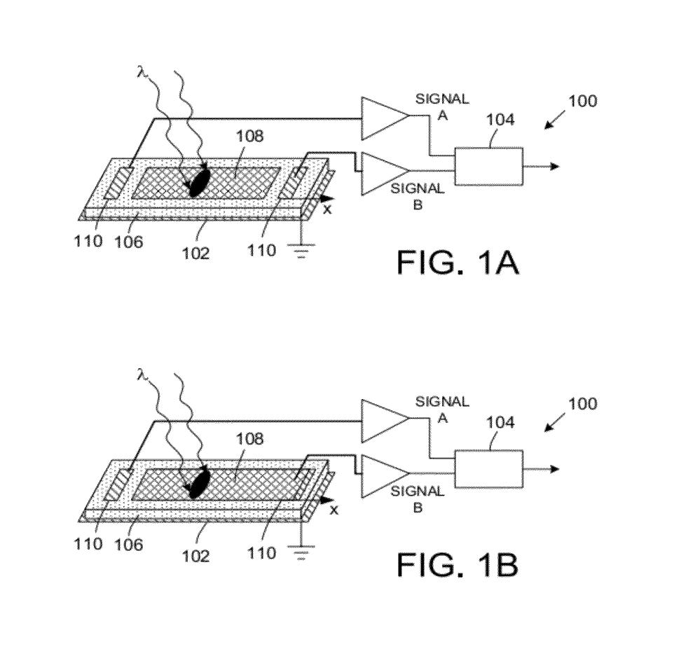

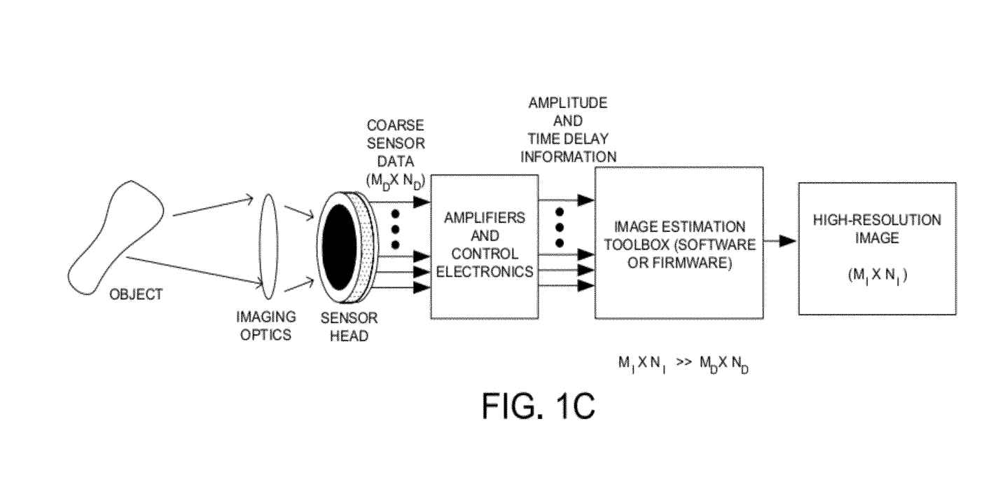

Referring to FIGS. 1A and 1B, pictorial and block diagrams depict embodiments of an apparatus 100 formed for sensing broadband electromagnetic (EM) radiation that comprises a sensor 102 and a controller 104. The sensor 102 can be configured to detect broadband electromagnetic (EM) radiation and generate electrical signals in response to the detected broadband EM radiation. The controller 104 is coupled to the sensor 102 and configured to receive the electrical signals and process the electrical signals to segment the sensor response to broadband EM radiation into a plurality of digitized pixels.

In various embodiments, several architectures can be configured to reduce or minimize the number of electrodes for imaging a large number of pixels. Some of the drawbacks of a sensor with a large number of electrodes connected to ROIC are the added cost associated with the ROIC circuit, the difficulty and cost of connecting the sensor to the ROIC, and occurrence of defective electrode elements. In illustrative embodiments of a sensing apparatus disclosed herein, various techniques and/or approaches reduce or minimize the number of electrodes, thus avoiding usage of a relatively complex ROIC and dense electronic arrays, for example as illustrated in FIG. 1C. Three example methods can include: (1) using time delay to detect signals to indicate the position of the incident photon; (2) using amplitude detection from multiple channels to indicate the position of the incident photon; and (3) using the frequency response of each pixel wherein the change in frequency response of the element indicates the position of the incident photon and thus the position of a pixel element. One-dimensional imaging (line scan) is enabled using two or more electrodes as shown in FIGS. 1A and 1B.

Accordingly, as shown in FIGS. 1A and 1B, embodiments of an apparatus 100 adapted for sensing broadband electromagnetic (EM) radiation can comprise a sensor 102 and a controller 104. The sensor 102 can comprise at least one piezoelectric layer 106, at least one absorbing layer 108 coupled to the piezoelectric layer 106, and a plurality of electrodes 110 coupled to the piezoelectric layer 106. The absorbing layer 108 can be configured to detect broadband electromagnetic (EM) radiation. The plurality of electrodes 110 can be configured to generate electrical signals in response to the detected broadband EM radiation. The controller 104 is coupled to the plurality of electrodes 110 and configured to receive the electrical signals and process the electrical signals to segment the sensor 102 into a plurality of digitized pixels.

In some embodiments, the sensor 102 can comprise at least one of a capacitive layer, a microelectromechanical system, a pyroelectric layer, a bolometer, and a microbolometer.

In still additional embodiments, the sensor 102 can further comprise at least one thermally conductive layer.

Referring to FIG. 1A, a perspective pictorial and block diagram illustrates an embodiment of a sensor configured for one-dimensional photo-acoustic imaging of broadband electromagnetic radiation using traveling elastic waves. The illustrative broadband photo-acoustic detection apparatus 100 is responsive to incident electromagnetic radiation of arbitrary shape and direction, thus arbitrary phase and amplitude, and comprises a darkened surface which absorbs incident electromagnetic (EM) radiation, an excitation electrode 110 and detection electrode 110, a piezoelectric material 106, a conductive layer which may also be used as ground plane. Some embodiments can further include a high-gain, low-noise amplifier and a band-pass filter (not shown). EM radiation is incident on the darkened surface. The excitation and detection electrodes are either a single element electrode, or are inter-digitated electrodes to generate and detect bulk or surface elastic waves. An excitation signal, such as a modulation signal or a pulse is applied to the excitation electrode, which generates elastic waves due to the piezoelectric effect. The wave travels along device, (surface or guided wave), and reaches the detection electrode 110, which generates a signal, again via the piezoelectric effect. Signal from the detection electrode 110 can be amplified and displayed. The amplified signal can pass through a band-pass or low-pass filter, and final signal can be displayed. If no EM radiation is present at the absorbing layer 108, then the signal is a smooth decaying signal. When EM radiation is present at the absorbing layer, then the absorbed radiation causes change in the dimension in the absorbed region due to thermal expansion, altering the traveling wave amplitude, and thus changing the visible signal. The time of occurrence of the change depends on the time of travel of the elastic wave and location and intensity of the incident radiation. The signal therefore indicates amplitude and location of the EM radiation, thus enables one-dimensional imaging of the incident EM radiation.

In an embodiment similar to that shown in FIG. 1A, either the excitation electrode of 110 or the detection electrode 110 or both can be inter-digitated electrodes or comb electrodes with either fixed pitch or variable pitch. Inter-digitated electrode width and pitch are designed to match the excitation signal frequency or frequency range to achieve optimum signal excitation and detection efficiency. In other embodiments, the sensor 102 can be implemented using a capacitive approach. Instead of piezoelectric material, electrode 110 can be replaced with an insulator. Suitable insulators may be a vacuum, air, or other insulators.

When electromagnetic radiation is incident on the absorbing surface or layer, the absorbed electromagnetic energy is converted to a mechanical energy via the photo-acoustic effect, and therefore changes the material dimensions, which then interferes with the traveling elastic wave. Because the detection method uses photo-acoustic effect, the technique can be used to image broadband electromagnetic radiation. The broadband spectrum can include, visible, infrared (IR), ultraviolet (UV) band, X-ray, microwave and higher or lower frequencies, as long as the radiation is absorbed by the absorbing surface of the sensor.

Referring to FIG. 1B, a perspective pictorial and block diagram illustrates an embodiment of a sensor configured for one-dimensional photo-acoustic imaging of broadband electromagnetic radiation using traveling elastic waves. The photo-acoustic imaging sensor 100 apparatus shown in FIG. 1A can be further modified by using an detection electrode 110 that has the same or similar size footprint as the absorbing layer 108, and the absorbing layer is coated over the detection electrode 110. In another embodiment similar to FIG. 1B either the excitation electrode 110 or the detection electrode 110 or both can be inter-digitated electrodes or comb electrodes with either fixed pitch or variable pitch. Inter-digitated electrode width and pitch should be designed to match the excitation signal frequency or frequency range to achieve optimum signal excitation and detection efficiency.

Referring to FIG. 1C, a schematic block diagram illustrates an imaging apparatus that uses an image detection scheme to generate high-resolution broad spectral band images from a coarse detector array.

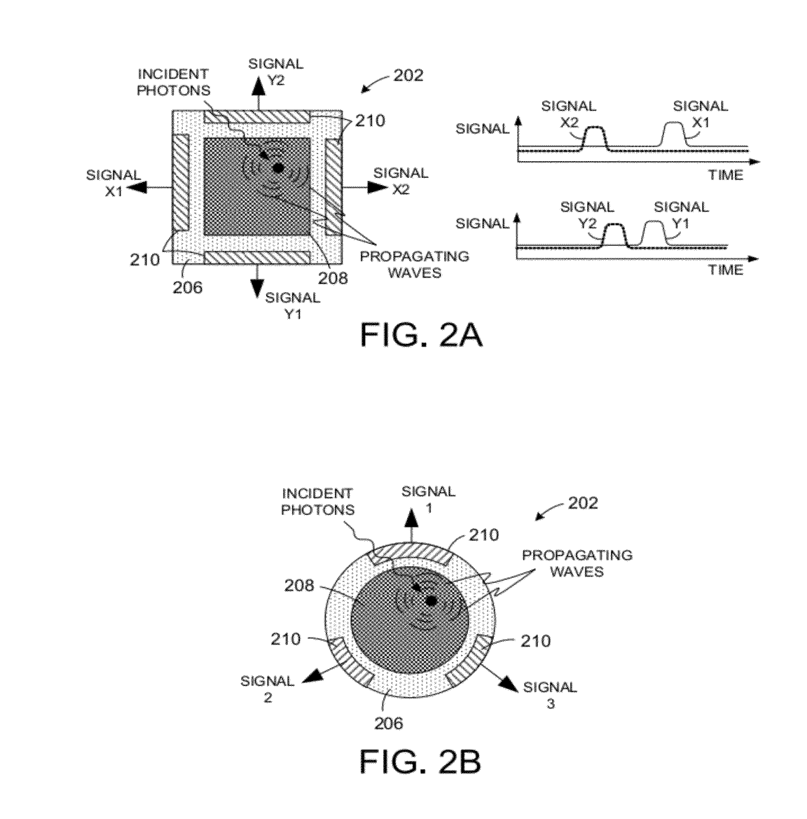

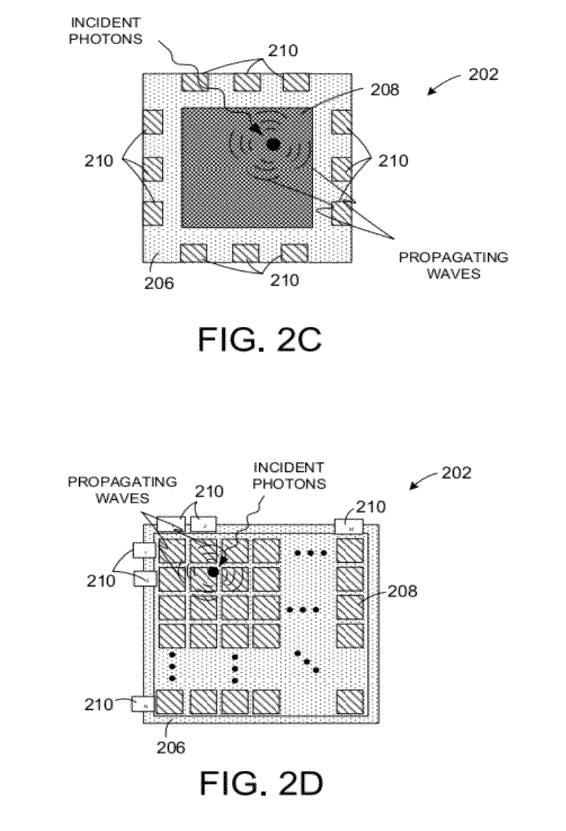

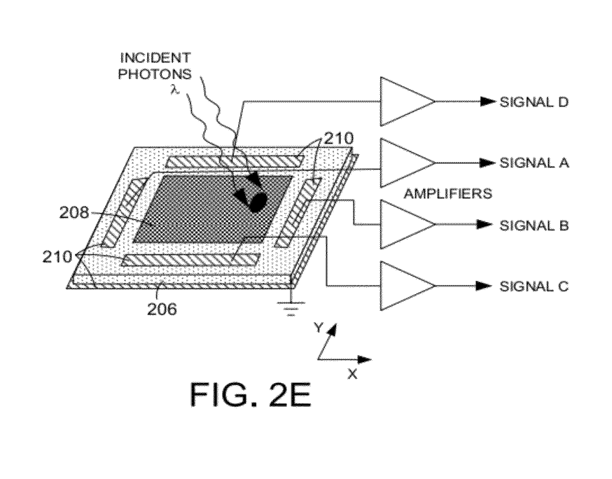

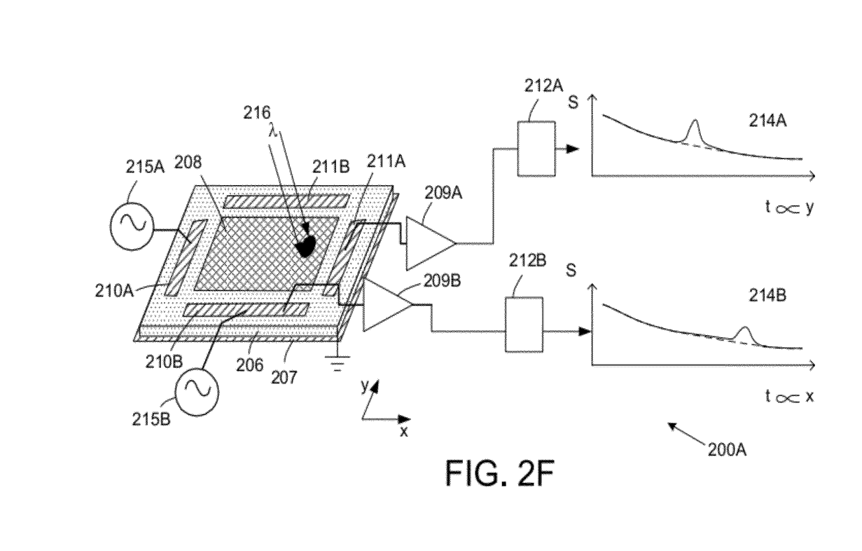

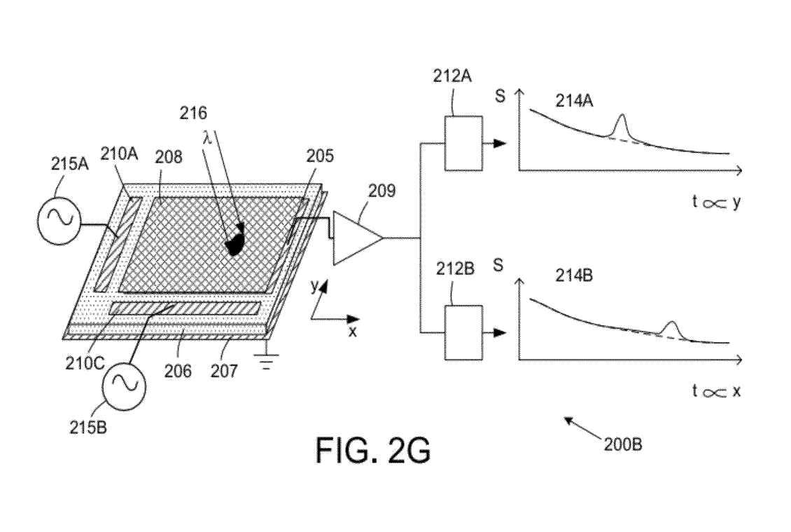

In contrast to the one-dimensional scanning sensor apparatus illustrated in FIGS. 1A and 1B, in other embodiments two-dimensional imaging can be achieved using three or more electrodes as depicted in FIGS. 2A, 2B, 2C, 2D, 2E, 2F, and 2G, which functions in a similar manner. FIG. 2A shows a top view of an architecture with four electrodes, for example a sensor 202 comprising a piezoelectric layer 206, an absorbing layer 208 coupled to the piezoelectric layer 206, and four electrodes 210 coupled to the piezoelectric layer 206. FIG. 2B is a top view of an architecture with three electrodes, for example a sensor 202 comprising a piezoelectric layer 206, an absorbing layer 208 coupled to the piezoelectric layer 206, and three electrodes 210 coupled to the piezoelectric layer 206. FIGS. 2C, and 2D show top views of architectures with multiple-electrode configurations. FIG. 2E is a perspective view illustrating details of a four-electrode scanning sensor architecture.

Referring to FIG. 2F, a perspective pictorial and block diagram illustrates an embodiment of a sensor 200A configured for two-dimensional photo-acoustic imaging of broadband electromagnetic radiation using traveling elastic waves. The photo-acoustic sensor apparatus shown in FIG. 1A is further modified to image two-dimensional incident EM radiation. Two excitation electrodes 210A and 210B and two detection electrodes 211A and 211B are used for generation and detection of traveling waves. To differentiate between x and y directions, the x-direction electrodes 210A and the y-direction electrodes 210B are excited with two different frequencies from sources 215A and 215B. The signals from detection electrodes 211A and 211B are sent to amplifiers 209A and 209B. The amplified signals are band-pass filtered 212A and 212B such that only certain frequencies are passed so that the x and y traveling wave signals are separated. The filtered x and y signals 214A and 214B indicate presence of EM radiation incident on the absorbing layer 208.

In another embodiment similar to FIG. 2F either one or both of the excitation electrodes 210A and 210B or one or both of the detection electrodes 211A and 211B or all the electrodes or any combination thereof are inter-digitated electrodes or comb electrode with either fixed pitch or variable pitch. Inter-digitated electrode width and pitch should be designed to match the excitation signal frequency or frequency range to achieve optimum signal excitation and detection efficiency.

Referring to FIG. 2G, a perspective pictorial and block diagram illustrates an embodiment of a sensor 200B configured for two-dimensional photo- acoustic imaging of broadband electromagnetic radiation using traveling elastic waves. The photo-acoustic imaging sensor 200A apparatus shown in FIG. 2F is further modified by using a single detection electrode 205 that has the same or similar size footprint as the absorbing layer 208, and the absorbing layer is coated over the detection electrode 205. Two excitation electrodes 210A and 210B are used to generate traveling wave signal generated from signal generators 215A and 215B. To differentiate between x and y directions, the x-direction electrodes 210A and the y-direction electrodes 210B are excited with two different frequencies from signal sources 215A and 215B. The signal from detection electrodes 205 is sent to amplifiers 209. The amplified signal is split into two and sent to two band-pass filters 212A and 212B such that only certain frequencies are passed so that the x and y traveling wave signals are separated. The filtered x and y signals 214A and 214B indicate presence and intensity distribution of EM radiation 216 incident on the absorbing layer 208.

In another embodiment similar to FIG. 2G either one or both of the excitation electrodes 210A and 210B or the detection electrode 205 or all the electrodes or any combination thereof, are inter-digitated electrodes or comb electrode with either fixed pitch or variable pitch. Inter-digitated electrode width and pitch should be designed to match the excitation signal frequency or frequency range to achieve optimum signal excitation and detection efficiency.

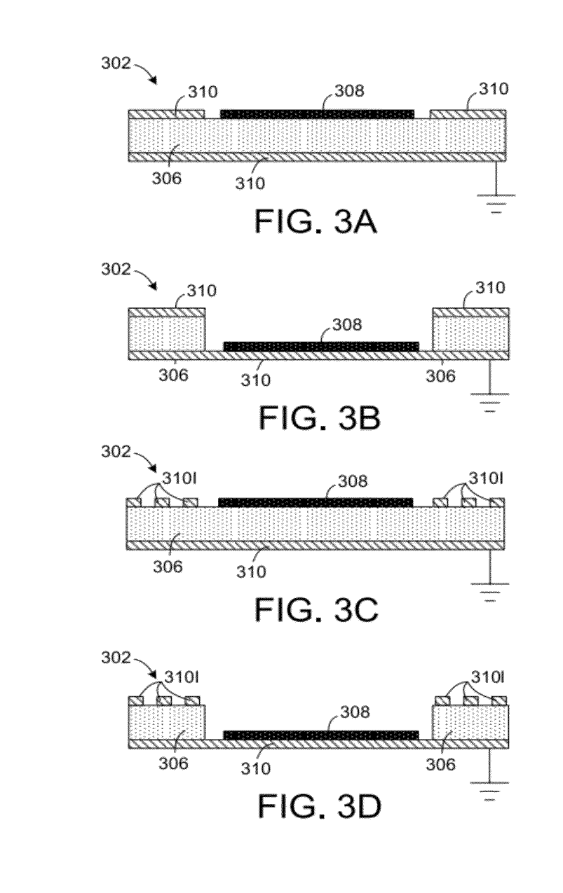

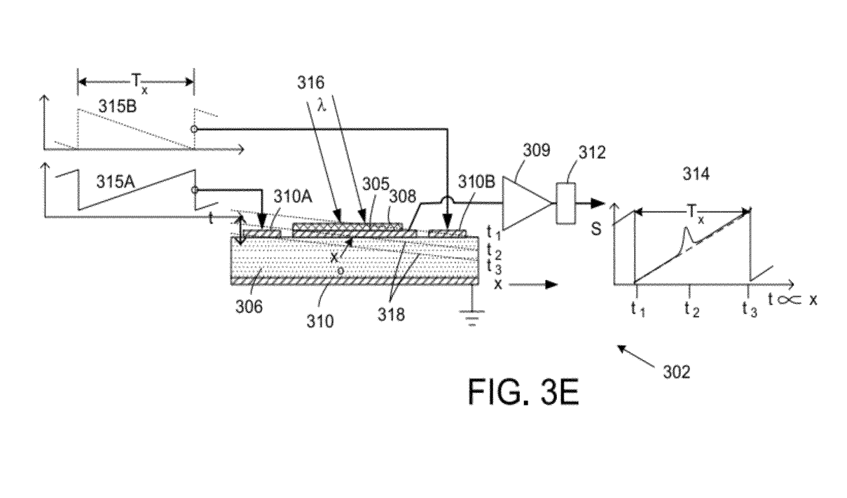

Referring to FIGS. 3A, 3B, 3C, and 3D, pictorial side views show embodiments of devices with various cross-sectional forms. FIGS. 3A, 3B, 3C, and 3D depict various sensor architecture cross-sections which include at least one piezoelectric layer 306, an absorbing layer 308, and one or more electrodes 310. FIGS. 3A and 3C show devices configured with a piezoelectric layer 306 that spans across the entire device 302. FIGS. 3B and 3D depict devices 302 which include a piezoelectric layer 306 only in the locations that top electrodes 310 are located. FIGS. 3C and 3D illustrate devices with interdigitated electrodes 3101.

Referring to FIG. 3E, a perspective pictorial and block diagram illustrates an embodiment of a sensor 302 configured for one-dimensional photo-acoustic imaging of broadband electromagnetic radiation. By applying a saw-tooth or a triangular modulated electrical signal 315A and 315B to excitation electrodes 310A and 310B, the material will expand or contract due to piezoelectric effect as shown in the dotted line 318. The detection electrode 305 is coated with an absorbing layer 308 to absorb the incident radiation 316. The signal from the detection electrode 305 is fed to a high-gain, low-noise amplifier 309 and an optional band-pass filter 312. The output signal 314 from the amplifier/filter is also modulated due to the excitation signal. When EM radiation is present at the absorbing layer 308, the absorbed radiation causes change in the dimension in the absorbed region due to thermal expansion. This change alters the output signal due the piezoelectric effect. EM radiation has maximum effect when the material is at is rest condition, namely, when change in dimension is minimum due to excitation effect. In this figure, at time t₂, point xₒ is equivalent to the rest position with no applied field. When the EM radiation 316 is incident at this spot, it has the maximum effect, and a change in the output signal 314 appears. Therefore, position of the change in the signal indicates the presence of EM field. Furthermore, the amplitude of this change is proportional to the incident radiation intensity. Therefore, the temporal position of the change indicates the x position, and the amplitude of the signal change indicates the intensity of the incident radiation, thus acting as a line scanner in the x direction.

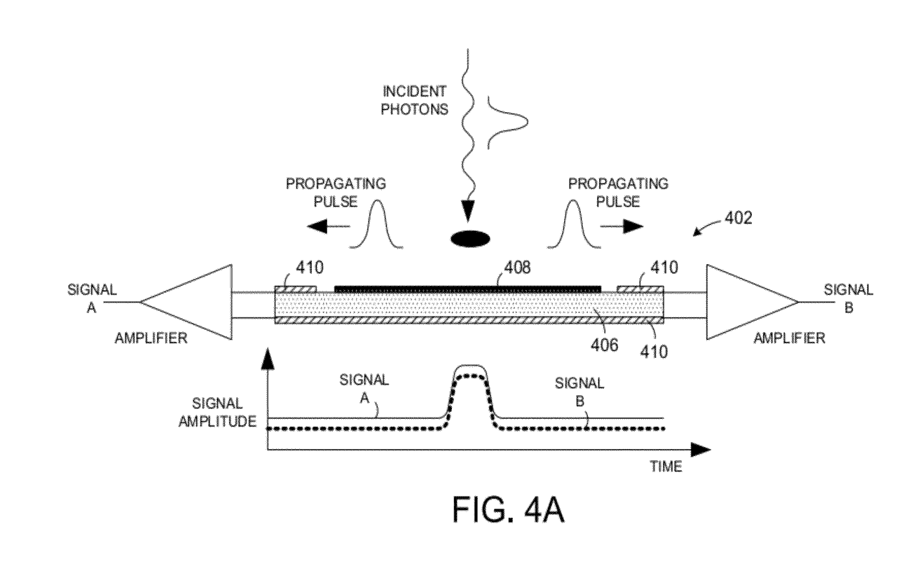

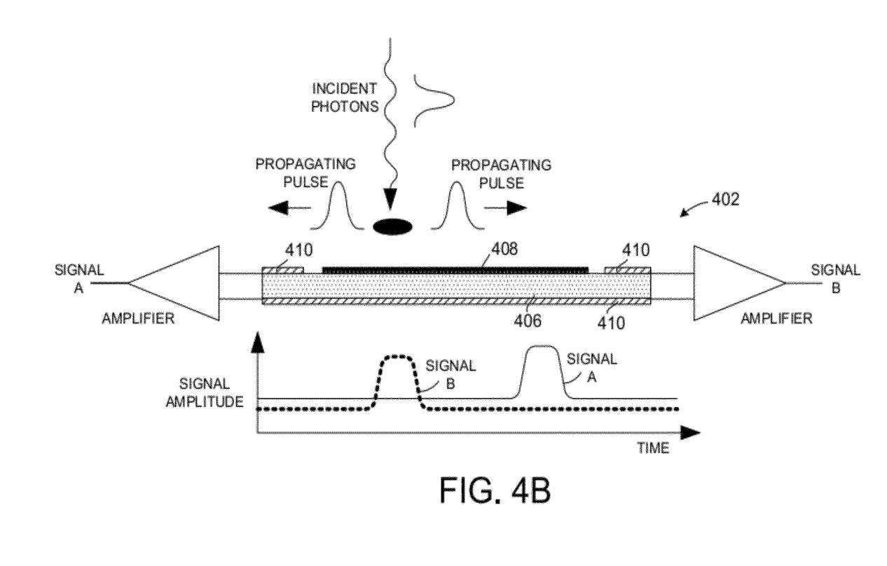

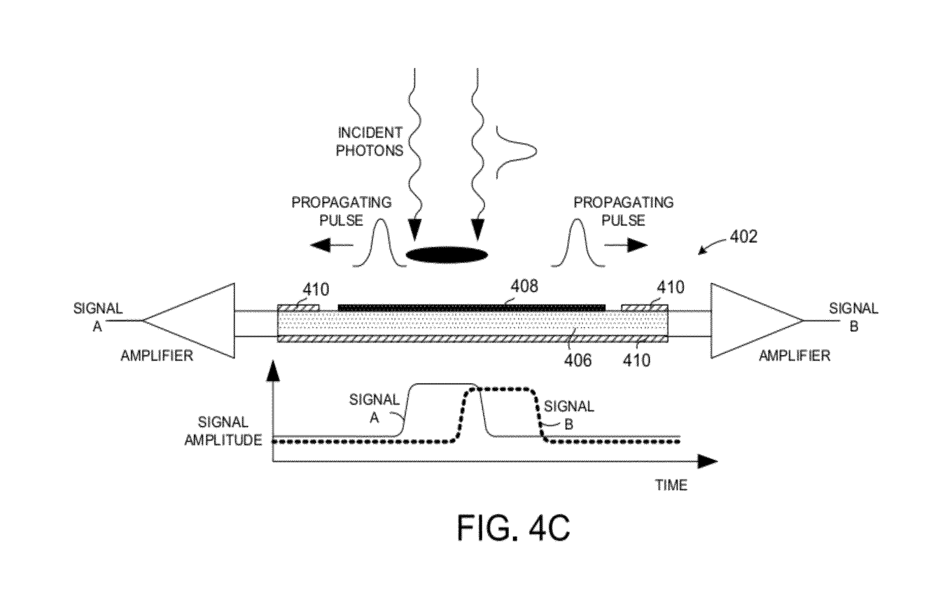

In some embodiments, a sensing device can perform a spatial scan of pulsed electromagnetic radiation using time delay. Spatial scanning can be performed using time delay measurements. Time delay can be measured, for example, by measuring time of arrival of a pulsed signal or a gated incident signal, by determining the time of arrival difference between one electrode or one pixel and another, or the like. Examples of device embodiments configured to perform a one-dimension time delay measurement is shown in FIGS. 4A, 4B, and 4C. In the depicted embodiment, a sensor 402 can comprise at least one piezoelectric layer 406, at least one absorbing layer 408 coupled to the piezoelectric layer 406, and a plurality of electrodes 410 coupled to the piezoelectric layer 406.

In these embodiments, in some embodiments the apparatus 100 can be configured wherein the controller 104 is configured to perform time delay measurements on signals from the plurality of pixels and use the time delay measurements to determine distance measurements and perform image mapping.

FIGS. 4A, 4B, and 4C are combined pictorial and circuit diagrams that depict sensors 402 which execute time-based detection of pulsed or modulated incident EM radiation. FIG. 4A shows signal detection when the incident photons are centered and illuminate a narrow region. FIG. 4B depicts signal detection when the incident photons are off-centered and illuminate a narrow region. FIG. 4C illustrates signal detection when the incident photons are off-centered and illuminate a wide region.

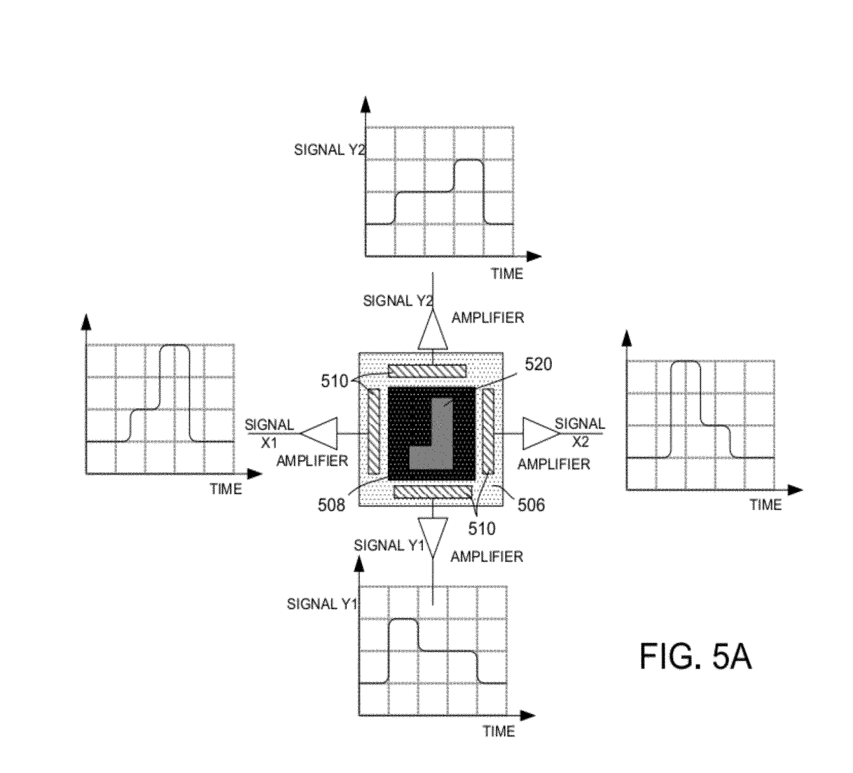

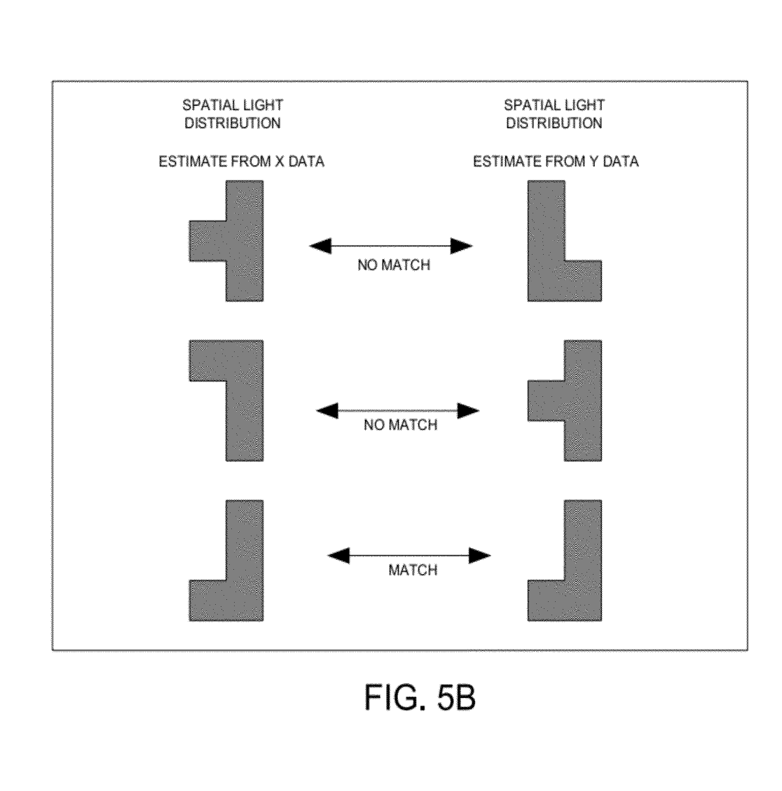

Two-dimension measurements can be obtained with a sensor configured with at least three sensing elements. FIG. 5A illustrates a sensor with three elements in which the time delay measurement reveals the possible shape of illumination distribution. Based on the x and y data, an image can be estimated as illustrated in FIG. 5B.

FIGS. 5A and 5B are pictorial and graphic diagrams which illustrate operation of an embodiment of a four-element sensor that produces time data from all four channels. In the depicted embodiment, a sensor 502 can comprise at least one piezoelectric layer 506, at least one absorbing layer 508 coupled to the piezoelectric layer 506, and a plurality of electrodes 510 coupled to the piezoelectric layer 506. The graphic diagrams show an example of pattern estimation. When the sensor is illuminated with the pattern shown in FIG. 5A, then four time signals are obtained. Analyzing the time signals from the four channels yields multiple possible solutions of the illumination pattern. When the estimated illumination pattern from both x and y channels match, then the correct illumination pattern is determined as depicted in FIG. 5B.

Accordingly, in some embodiments the apparatus 100 can be configured wherein the controller 104 is configured to match patterns from signals of selected ones of the plurality of pixels and perform image estimation according to the matched patterns.

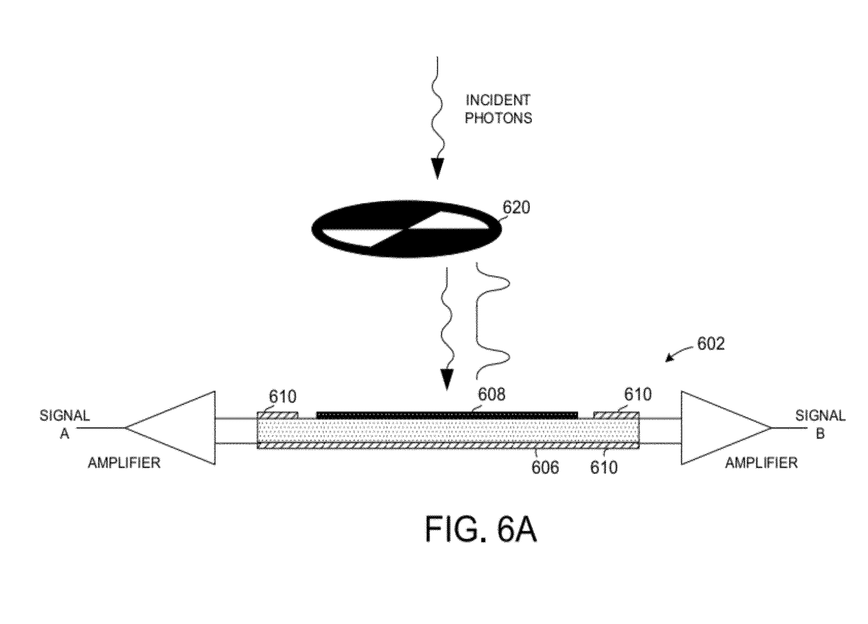

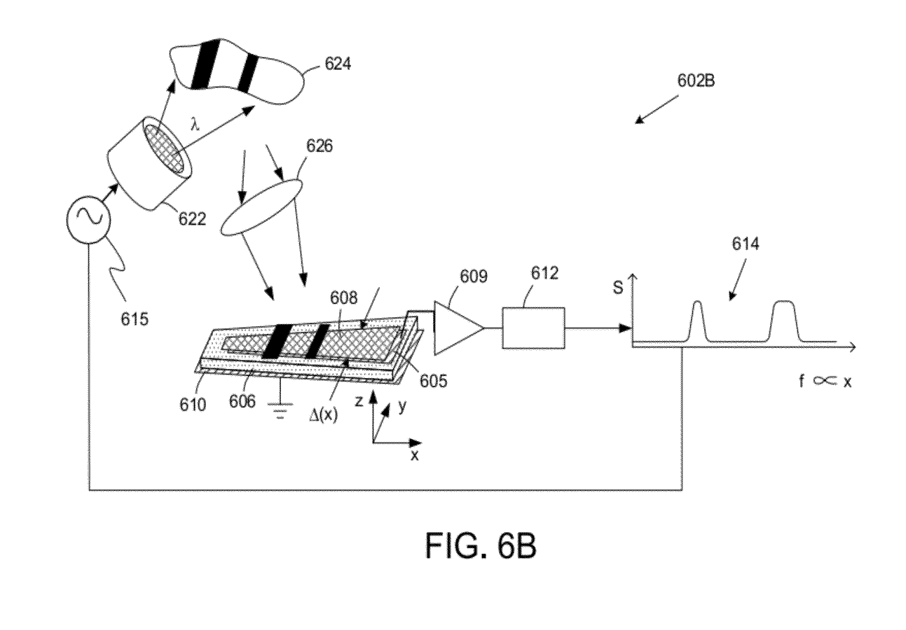

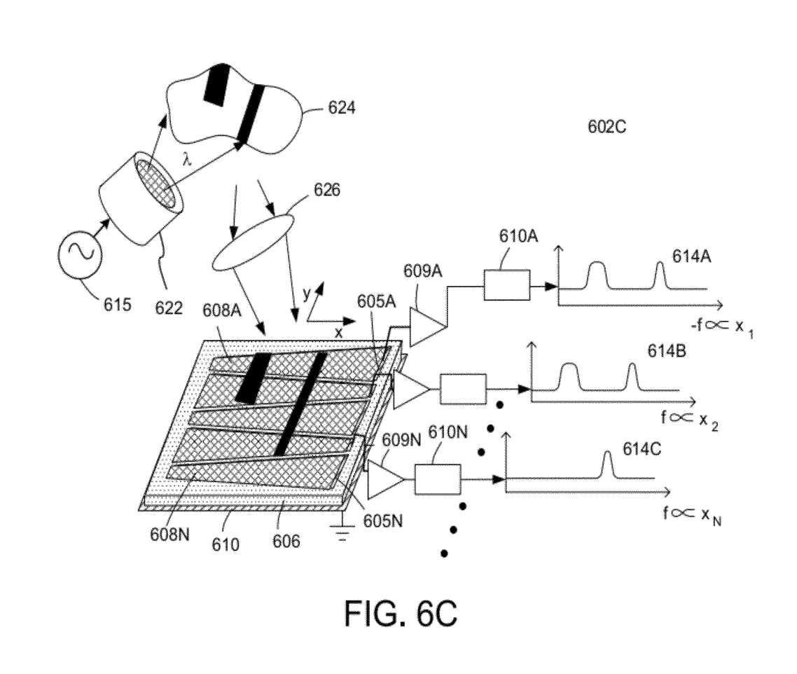

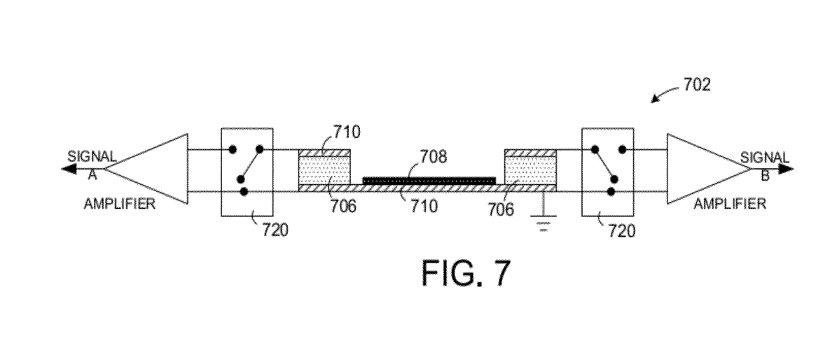

In some embodiments, a sensing device can perform a spatial scan of modulated electromagnetic radiation using signal amplitude. Signal amplitude can be used to produce a line image of the sample. Various methods of modulation can be performed, as depicted in FIGS. 6A, 6B, 6C and FIG. 7, for example by using mechanical choppers, a liquid crystal light modulator, an electro-optic light modulator, electrical, electronic or electro-optic switch, or any kind of modulation scheme.

Accordingly, in some embodiments the apparatus 100 can be configured wherein the controller 104 is configured to perform imaging using at least one measurement selected from a time delay measurement, a frequency response measurement, an amplitude measurement, a cross-talk measurement, and other similar suitable measurements. The selected one or more measurements can comprise a modulation method such as mechanical choppers modulation, liquid crystal light modulation, an electro-optic light modulator, electrical switching, electronic switching, electro-optic switching, source modulation, and the like.

FIG. 6A is a schematic pictorial and circuit diagram depicting a sensor 602 that executes detection using a chopper or modulator 620. In the depicted embodiment, a sensor 602 can comprise at least one piezoelectric layer 606, at least one absorbing layer 608 coupled to the piezoelectric layer 606, and a plurality of electrodes 610 coupled to the piezoelectric layer 606. The modulator 620 can be a mechanical chopper, a liquid crystal light modulator, an electro-optic light modulator, or any other suitable modulation scheme.

Referring to FIG. 6B, a perspective pictorial and block diagram illustrates an embodiment of a sensor 602B configured for one-dimensional photo-acoustic imaging of broadband electromagnetic radiation. The EM source 622 which illuminates an object 624 is modulated. The modulated EM radiation reflects from the surface of objects, carrying spatial information about the object. An optional lens 626 or imaging optics is used to focus the reflected or scattered EM radiation from the object 624 onto the sensor absorbing surface 608. The electrode 605 is connected to a high-gain, low-noise amplifier 609 and to an optional band-pass filter to filter out unwanted noise. The detected signal 614 is displayed in a frequency plot. The signal has highest modulation amplitude when the source modulation frequency matches the resonant frequency of the spot in x direction, which is controlled by the width Δ(x) of the tapered electrode 605. Therefore scanning the frequency yields the spatial and amplitude distribution of the incident radiation, namely object reflection.

In another embodiment, the band-pass filter 612 in FIG. 6B can be replaced with a frequency detecting electronic circuit and the signal 614 yields change in modulation frequency due to presence of incident radiation, and yields the spatial and amplitude distribution of the incident EM radiation.

Yet in another embodiment, the band-pass filter 612 in FIG. 6B can be replaced with a phase detecting electronic circuit and the signal 614 yields change in phase of the modulation signal due to presence of incident radiation, and yields the spatial and amplitude distribution of the incident EM radiation.

In another embodiment, the EM source 622 can be placed to illuminate the object 624 from the back, thus the detected signal 614 reveals the optical transmission characteristics of the object 624.

Yet in another embodiment the tapered electrode 605 in FIG. 6B, the overlaying absorptive coating 608, the piezoelectric layer 606 and the ground plane 610 can be of any arbitrary shape that will span any range of frequencies to yield spatial distribution of the incident radiation. Specific shape parameters are application-specific, and are chosen considering image size, resolution.

Referring to FIG. 6C, a perspective pictorial and block diagram illustrates an embodiment of a sensor 602C configured for two-dimensional photo-acoustic imaging of broadband electromagnetic radiation. The EM source 622 which illuminates an object 624 is modulated. The modulated EM radiation reflects from the surface of objects, carrying spatial information about the object reflection. An optional lens 626 or imaging optics is used to focus the reflected or scattered EM radiation from the object 624 onto the sensor absorbing surface 608A to 608N. The electrodes 605A to 605N are connected to a high-gain, low-noise amplifiers 609A to 609N and to an optional band-pass filters 610A to 610N to filter out unwanted noise. The detected signals 614A to 614N are displayed in a frequency plot. The signal has highest modulation amplitude when the source modulation frequency matches the resonant frequency of the spot in x direction, which is controlled by the width Δ(x) of the tapered electrode 605A to 605N. Therefore scanning the frequency yields the spatial and amplitude distribution of the incident radiation, namely object reflection. The electrodes 605A to 605N are tapered either in the same x direction, or in an opposite direction, as depicted. If they are of alternating taper direction, then the signal output has to be displayed accordingly, specifically, 614A to 614N are displayed in f and −f directions.

In another embodiment, the band-pass filters 612A to 612B in FIG. 6C are replaced with frequency detecting electronic circuits and the signals 614A to 614B yield change in modulation frequency due to presence of incident radiation, and yields the spatial and amplitude distribution of the incident EM radiation.

In another embodiment, the band-pass filters 612A to 612B in FIG. 6C are replaced with phase detecting electronic circuits and the signals 614A to 614B yield change in modulation frequency due to presence of incident radiation, and yields the spatial and amplitude distribution of the incident EM radiation.

Yet in another embodiment the tapered electrodes 605Aa to 605N in FIG. 6C, the overlaying absorptive coatings 608A to 608N, the piezoelectric layer 606 and the ground plane 610 can be of any arbitrary shape that will span any range of frequencies to yield spatial distribution of the incident radiation. Specific shape parameters are application-specific, and are chosen considering image size, resolution.

FIG. 7 is a schematic pictorial and circuit diagram showing a sensor 702 configuration that performs detection of static EM radiation (DC) using an electrical switching circuit 720. In the shown embodiment, the sensor 702 can comprise at least one piezoelectric layer 706, at least one absorbing layer 708 coupled to the piezoelectric layer 706, and a plurality of electrodes 710 coupled to the piezoelectric layer 706. The switch 720 can be a mechanical, electrical, electronic or electro-optic switch. Examples of suitable techniques can include periodically grounding the signal, or using transistor switching circuit, such as using field effect transistor (FET).

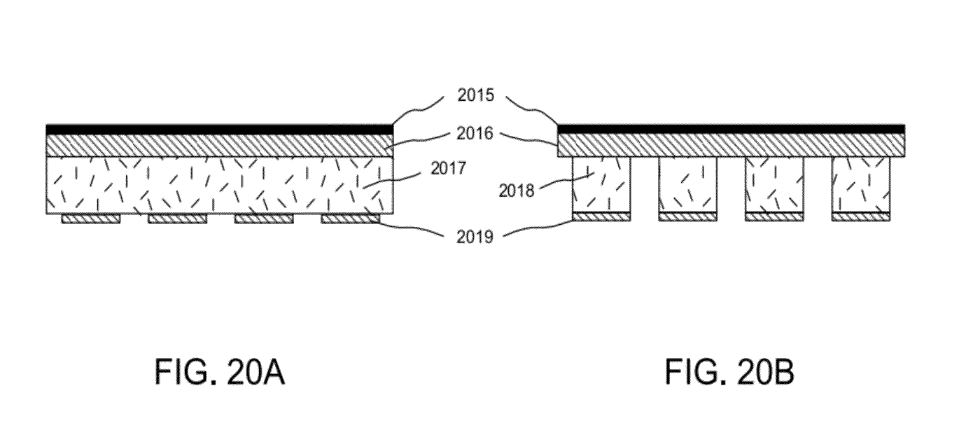

In other embodiments, for example as depicted in FIGS. 19A through 19D and FIGS. 20A and 20B, other sensor geometries can be used.

Referring to FIGS. 20A and 20B, cross-sectional cut-away pictorial views show embodiments of structures for spatial sampling of a broadband EM image. Spatial sampling can be achieved by various techniques including usage of a pixelated or multi-element sensor, a moving slit or iris in front of a single element sensor, by scanning a single element sensor, or other suitable method.

Images can be captured through a pixelated sensor scheme. One scheme utilizes a pixelated piezoelectric transducer (PZT) or capacitive sensor. The cross-sections of two different pixelation scheme embodiments are shown in FIGS. 20A and 20B. A pixelation scheme for a photo-acoustic sensor is shown in FIG. 20A. Only a back conductor 2019 is pixelated. In FIG. 20B, both a conductor 2019 and piezoelectric material 2018 are pixelated. The devices contain an absorbing layer 2015, a conductor 2016 such as a brass layer), piezoelectric material 2017 in unpatterned form, or in the case of a capacitive detection technique the piezoelectric material can be replaced by a dielectric insulator or air. The configuration shown in FIG. 20B contains a patterned piezoelectric material 2018, or dielectric material or air if a capacitive detection is used. The back side is coated with conductors 2019.

The pixelation method shown in FIGS. 20A and 20B can be implemented either mechanically such as by micro-machining using diamond cutting or dicing, or lithographically. For a lithographic technique, the PZT device can be spin coated with a photo-resist, pixels patterned using a mask aligner, and electrodes etched using metal etching, and the PZT material. For the architecture shown in FIG. 20B, or for a dielectric material if a capacitive method is used, materials can be etched using ion milling or reactive ion etching.

The illustrative pixelation methods and structures shown in FIGS. 20A and 20B can be implemented for a sensor constructed from any suitable photo-acoustically sensitive material including piezoelectric materials and capacitive materials.

In various embodiments, a sensing device can perform scanning via amplitude detection from multiple channels. By comparing signal amplitudes of various pixels, an image can be obtained that is beyond the resolution limited by the pixel pitch. The signal from neighboring region can propagate to other pixels by elastic wave propagation, surface wave propagation or thermal diffusion or by another other similar mechanism. Since the signal propagates towards all the neighboring elements, detecting the signal ratio determines the location of the source of the signal. Therefore using the signal from multiple pixels and by matching all the estimated illumination locations from each pixel yields the distribution of the incident photons, enabling imaging at resolution much higher than what is allowed by the pixel pitch.

Thus, in some embodiments the apparatus 100 can be formed wherein the controller 104 is configured to generate an image by comparing signals from at least two pixels of the plurality of pixels.

Furthermore, in various embodiments the apparatus 100 can be constructed such that the controller 104 is configured to generate an image by comparing signals from neighboring pixels of the plurality of pixels.

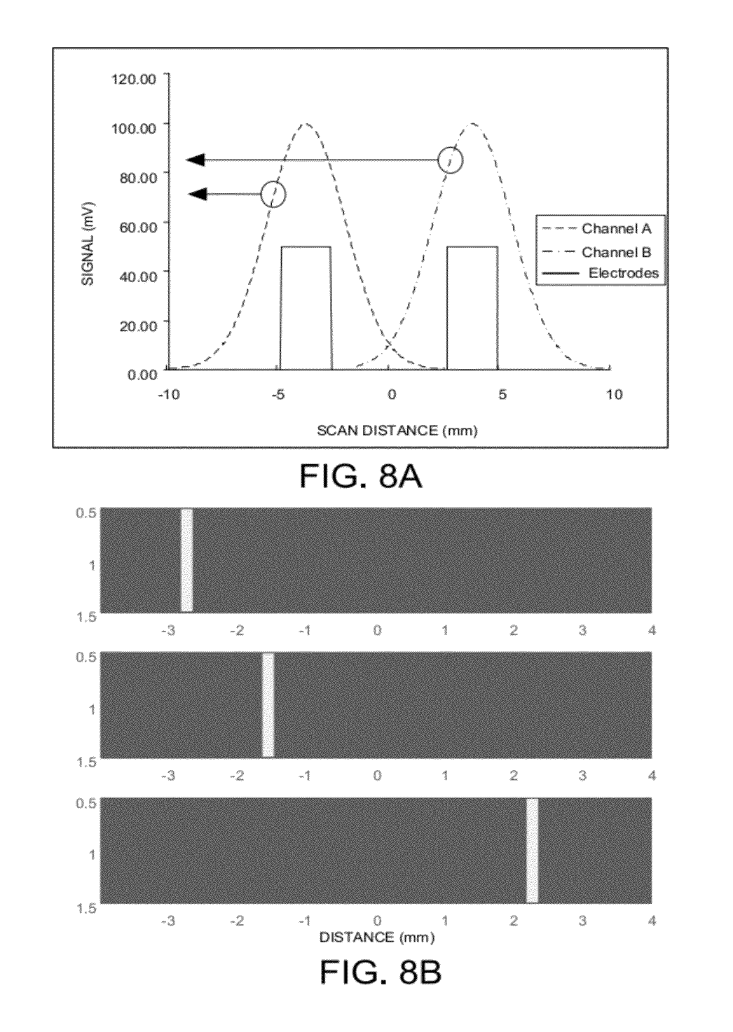

FIGS. 8A and 8B are, respectively, a graph showing pixel calibration data in which signal amplitude is depicted as a function of scan distance, and an illumination pattern at three locations. In the illumination spot representation illustrated in FIG. 8B, estimated illumination is shown at three different locations, with x=−2.7 mm, −1.5 mm and 2.3 mm, from top to bottom.

An example of a line scan using two coarse elements is shown in FIGS. 8A and 8B. The location of a photon is predicted at much finer steps than the pixel pitch, as indicated in FIG. 8B.

The illustrative detection scheme can be used to locate incident photons. For example, amplitude detection can be used for locating a laser beam spot, ultra-violet (UV), visible, infrared (IR) illumination spot, a terahertz (THz), microwave or millimeter wave illumination spot. The location can be in a line, for example using one or two detectors, or locating the illuminating spot in a plane via multiple detection electrodes.

Similarly, by using multiple electrodes, an image can be estimated by detecting an image signal from multiple sensing elements which yield various amplitudes, and by analyzing the amplitude to reconstruct an image. In the manner of the time delay detection described with reference to FIGS. 5A and 5B, the estimated image pattern from all sensing elements matches. The matched pattern represents the incident illumination pattern.

Various embodiments of a sensing apparatus can perform phase measurements. In an array sensor configuration, for example with a geometry such as is shown in FIGS. 2A through 2H, cross-talk is present between sensing elements. A signal that is generated as a result of a photon absorbed at one location decays in amplitude and is delayed in time. The amplitude decay and time delay are proportional to the distance between the signal source and the detector element, a condition that is illustrated in the graph associated with FIG. 2A. Referring to FIG. 1C, the amplitude decay and time delay information obtained from a coarse detector array of size (M_{D}×N_{D}) can be used to recreate a high resolution (M_{I}×N_{I}) image, where M_{I}×N_{I} is much larger than M_{D}×N_{D}.

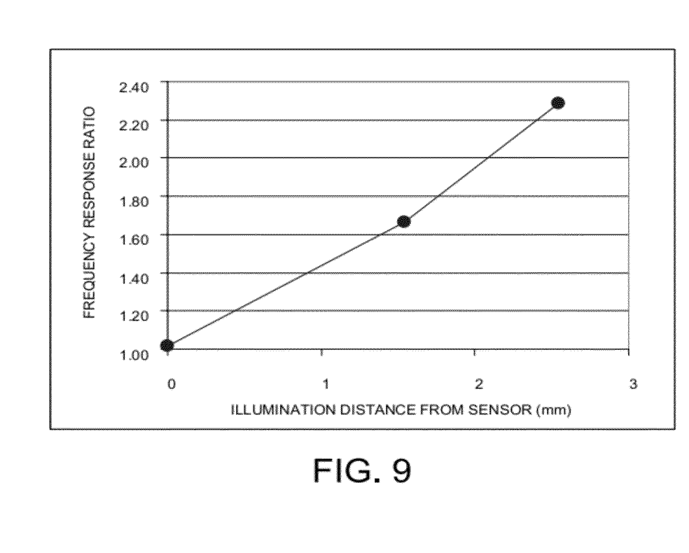

In various embodiments, a sensing device can perform frequency measurements to determine distance estimation. Rather than performing time delay measurements such as is shown in FIGS. 5A and 5B, distance information can be otherwise obtained from frequency measurements. For example, if the detected signal is modulated due to incident photon modulation, for example using a chopper wheel in front of the detector, by electronically modulation, then the frequency response of the pixel is dependent on the distance between the illumination spot and the detection pixel. The frequency response changes with respect to pixel distance from the sensor, as depicted in FIG. 9. Measuring the frequency response of the sensor yields the distance of the signal from that pixel. The frequency response data can be used alone or in combination with amplitude measurements to identify the location of the photon. Repeating the frequency response and/or amplitude analysis for each pixel enables determination of a map of the incident photons and produces an image.

FIG. 9 is a schematic graph that depicts an example of frequency response change with respect to distance between illuminated area and the sensing pixel.

Accordingly, in some embodiments the apparatus 100 can be constructed such that the controller 104 is configured to perform frequency response measurements on signals from the plurality of pixels and use the frequency response measurements to determine distance measurements and perform image mapping.

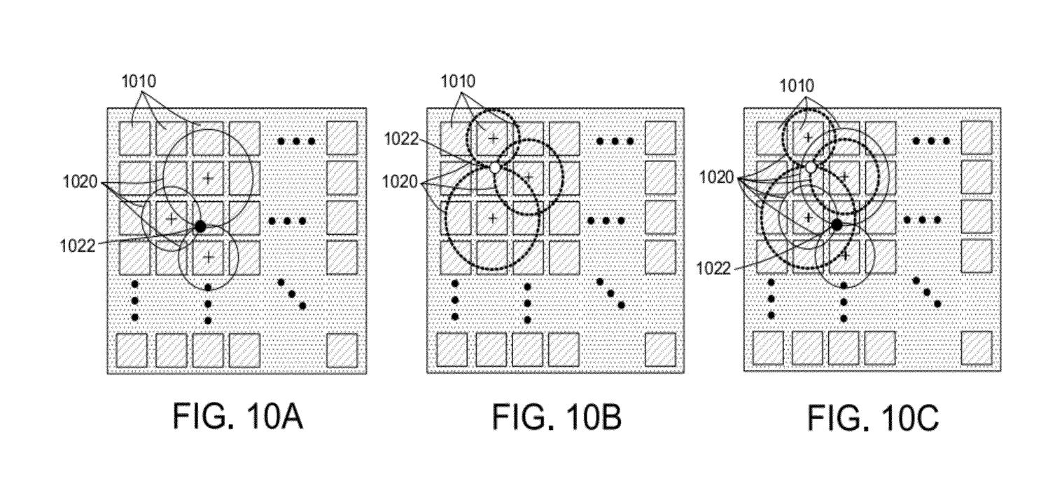

In some embodiments and/or conditions, a sensing device can attain an image resolution that is greater than pixel pitch. The distance of the signal source from the measuring pixel can be measured, enabling an image at much higher resolution than pixel pitch can be obtained. A distance measurement from time delay measurements or frequency response measurements can be used to triangulate the signal, and map the incident photon distribution, as depicted in FIGS. 10A, 10B, and 10C. The triangulation data, either alone or in combination with amplitude detection, can enable image resolution much finer than the pixel pitch, thus allowing high resolution imaging with coarse resolution sensor.

Accordingly, in some embodiments the apparatus 100 can be constructed such that the controller 104 is configured to compare signals from selected pixels of the plurality of pixels and use the compared signals to perform distance and intensity measurements and perform image mapping.

Furthermore, in some embodiments the apparatus 100 can be formed such that the controller 104 is configured to perform high resolution imaging using coarse resolution pixels.

Similarly, in various embodiments the apparatus 100 can be formed such that the controller 104 is configured to perform high resolution imaging using coarse resolution pixels comprising at least one measurement selected from a group consisting of time delay measurement, frequency response measurement, and cross-talk measurement.

FIGS. 10A, 10B, and 10C are pictorial graphic diagrams showing examples of triangulation or trilateration using distance measurement from time delay or frequency response method for locating illumination spot for usage by embodiments of sensor devices. FIGS. 10A and 10B illustrate a single spot location estimate in which signals from a plurality of electrodes 1010 use the time delay or frequency response method to determine estimated distances from time delay 1020 for an illuminated spot 1022. FIG. 10C shows a double spot location estimate.

Accordingly, in some embodiments the apparatus 100 can be constructed such that the controller 104 is configured to map incident photons using triangulation or trilateration.

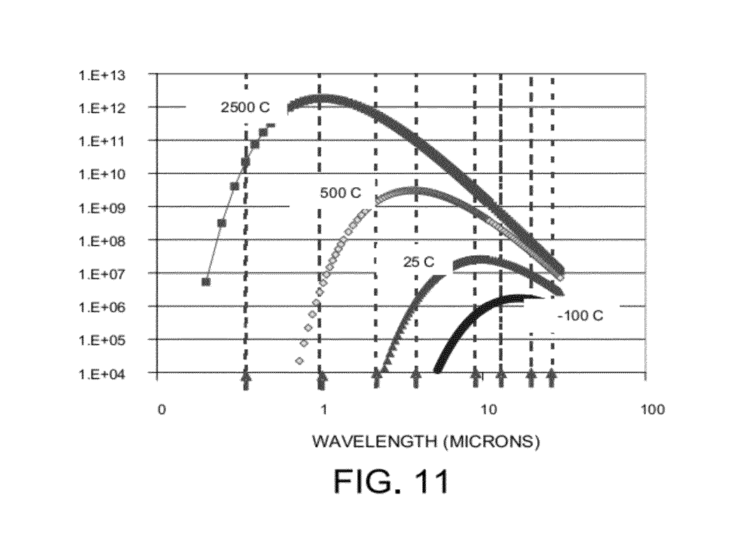

In some embodiments and/or conditions, a sensing device can perform extreme temperature sensing. Broad spectral band sensors can be used for extreme temperature and radiation sensing. To detect extreme temperature of a surface, for example from −100 to 2500 deg. C., a sensor can be used that responds from ultraviolet (UV) to far infrared (IR). Thus from wavelengths of 0.35 nm to 30 microns. A suitable sensor can achieve several orders of magnitude dynamic range, for example six orders of magnitude detection range. The extreme range detection is depicted in the blackbody radiation plot shown in FIG. 11.

FIG. 11 is a blackbody radiation plot showing an example of blackbody radiation emission for an embodiment of a sensor that performs extreme temperature and radiation sensing. The illustrative blackbody radiation emission is shown for surfaces with temperature from −100° C. to 2500° C.

Accordingly, in some embodiments the apparatus 100 can be configured as a multiple-element broad-spectral band sensor 102 operable to detect from ultraviolet (wavelength 0.35 nm) to far infrared (wavelength 30 microns). The controller 104 can be configured to sense temperature using the broad spectral band sensor 102.

For example, if an eight-element detection system is used with center wavelengths indicated in the arrows shown in FIG. 11, with detection range of six orders of magnitude or better, then the surface temperature of the blackbody source can be assessed for a range of −100° C. to 2500° C. and higher.

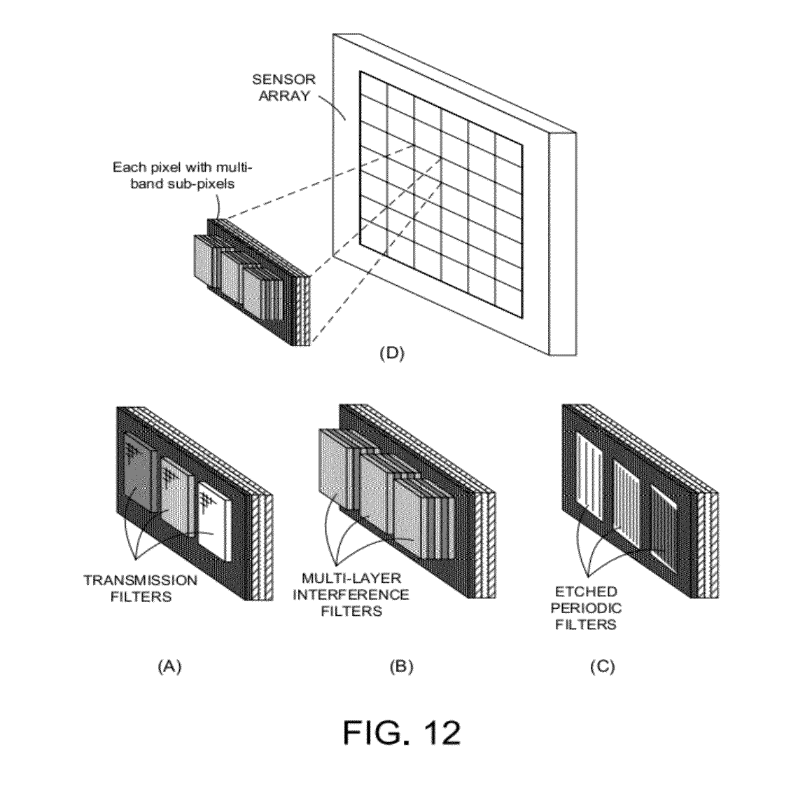

In some embodiments and/or conditions, a sensing device can perform multiple-spectral and hyper-spectral detection. To achieve multi-spectral detection, a multi-element sensor can be used with integrated spectral filter, as depicted in FIG. 12.

FIG. 12 depicts wavelength filtering using a) transmission filters, b) multi-layer interference filters using multi-layer alternating materials of different refractive index, and c) using etched periodic gratings of a particular period, such that they diffract certain wavelength bands. d) Filters attached on a sensor array, with each filtered element yielding a signal in a particular wavelength band. Sub-band selection is achieved using any of the filter arrangements shown in (a), (b) or (c), or any combination thereof.

In other embodiments similar to FIG. 12 wavelength tuning can be achieved using a single element sensor using one- or two-dimensional scanning using any other methods disclosed with respect to the other figures depicted herein, while the sensor is covered with various filters at different locations.

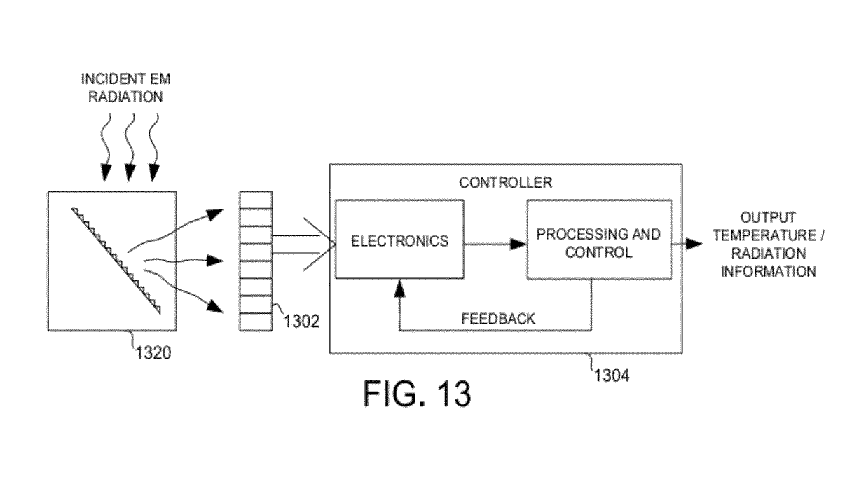

Another approach is to couple the sensor array to a spectrometer as shown in FIG. 13. Accordingly, in some embodiments the apparatus 1300 comprising a sensor 1302 and a controller 1304 can further comprise a spectrometer 1320 configured to reflect incident electromagnetic radiation to the at least one piezoelectric layer. The spectrometer 1320 can include a spectrometer and optics. The sensing apparatus 1300 includes an ultra broad spectral band sensor array 1302.

FIG. 13 is a schematic block diagram that depicts a sensing apparatus 1300 that includes a spectrometer 1320 to perform spectroscopic sensing and surface and blackbody temperature detection.

Similarly, when a large number array is coupled to an imaging spectrometer, a hyper-spectral detection can be achieved. Various methods of producing a large number array can be used.

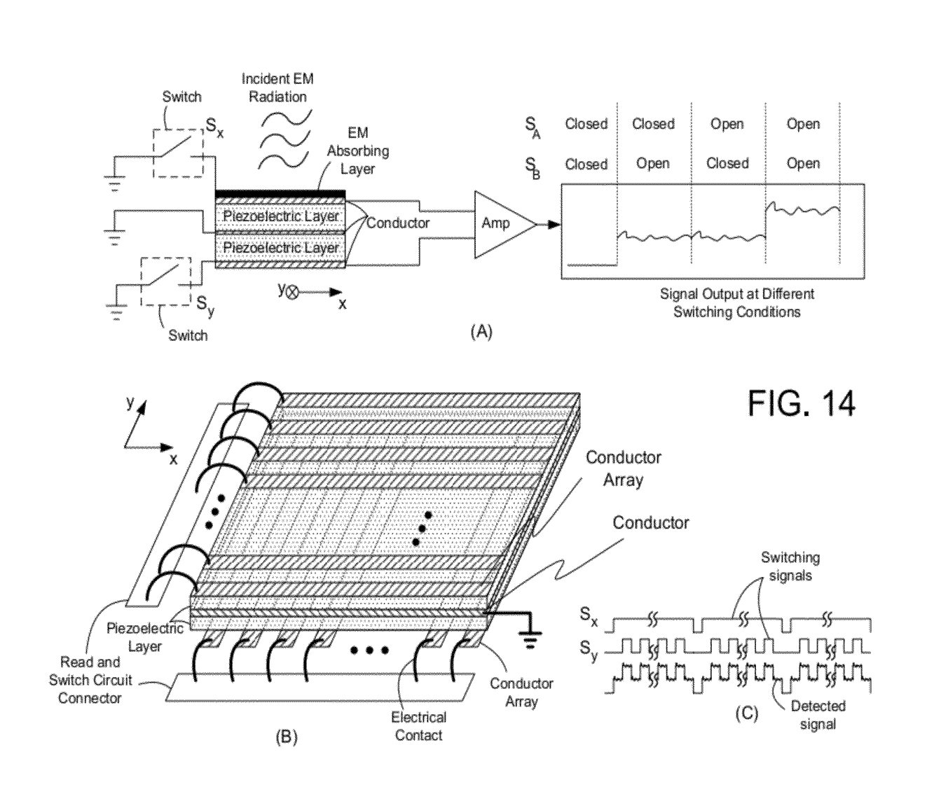

For example, FIG. 14 depicts a method of generating two-dimensional image data using multi-layer device. A) Cross section of a single element and signal switch and detection details. B) Device with multiple pixels. C) Switching and detection signals with a multiple pixel device. Sx and Sy refer to x and y switches in (A) and the corresponding drive signals. Sensor system parameters, namely the piezoelectric layer poling direction, the amplifier polarity, the ground plane for each layer and any subsequent phase shifters used after each line are configured such that x and y switches are on, will get the highest signal.

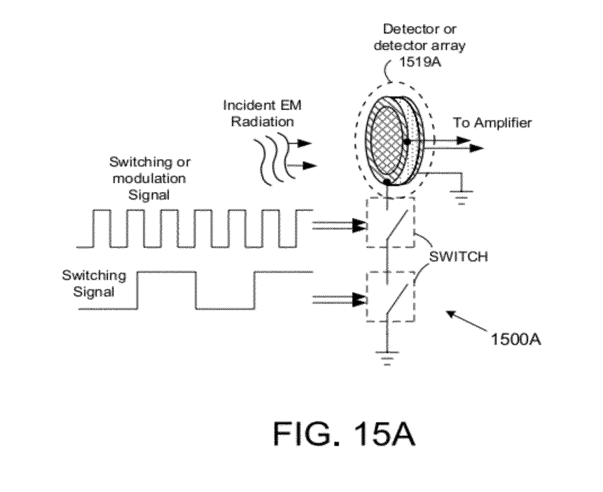

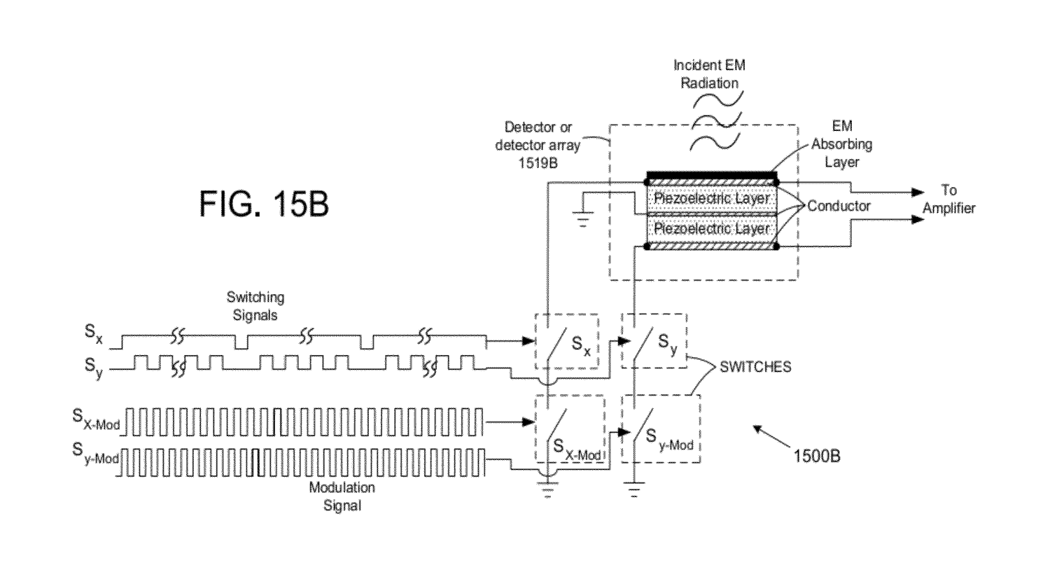

FIG. 15A depicts a double switching apparatus 1500A to be used with the broadband sensors depicted throughout. One of the switches is used for modulating the signal to reduce the background noise and, and the other switch is used to either the scan the sensor for 1-dimensional and 2-dimensional images.

In other embodiments similar to FIG. 15A, the detector head 1519A can be replaced with any of the 1-dimensional or 2-dimensional sensor heads depicted throughout the disclosure.

In other embodiments, either or all the switching and modulating signals can be digital signals. In still other embodiments, either or all the switching and modulating signals can be analog signals. In further embodiments, either or all the switching and modulating signals can be digital signals, analog signals, a combination of digital and analog signals, or any arbitrary shaped signal.

FIG. 15B depicts a double switching apparatus to be used with the broadband sensors depicted throughout. One of the switches is used for modulating the signal to reduce the background noise and, and the other switch (such as Sx or Sy) are used to scan the sensor for imaging as depicted in FIG. 14.

In other embodiments similar to FIG. 15B, the modulating signals S_{x-mod} and S_{y-mod} can have the same frequency.

In other embodiments similar to FIG. 15B, the modulating signals S_{x-mod and S}_{y-mod} can have different same frequencies.

In other embodiments, either one, -two, -three, or all the switching and modulating signals can be digital signals.

In other embodiments, either one, -two, -three, or all the switching and modulating signals can be analog signals.

In other embodiments, either one, -two, -three, or all the switching and modulating signals can be digital signals, analog signals, a combination of digital and analog signals, or any arbitrary shaped signal.

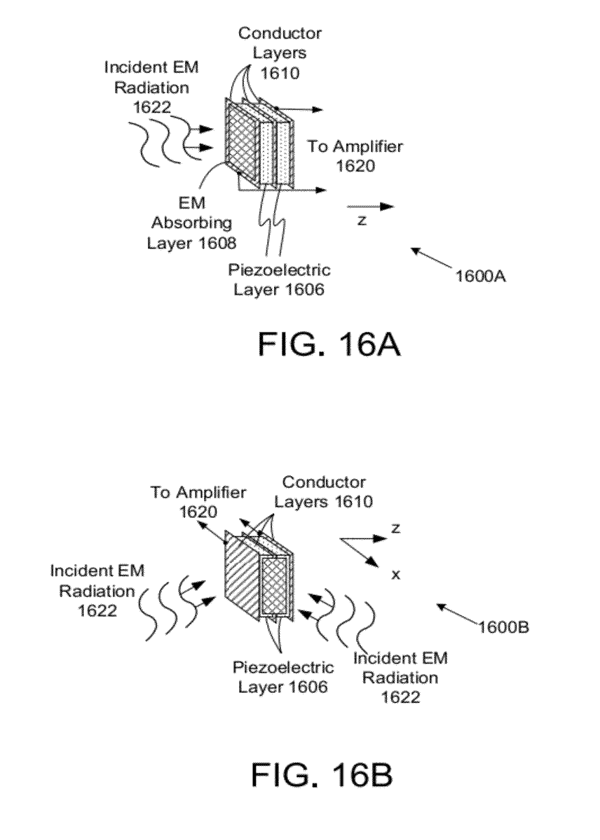

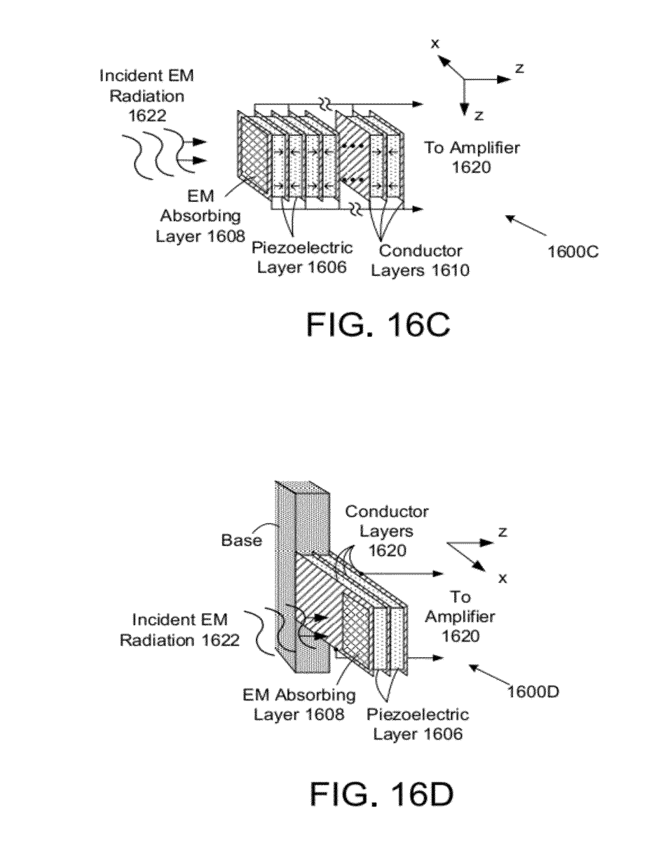

In some embodiments and/or conditions, a sensing device can perform various methods for enhancing detection range. Various embodiments of broadband sensors are configured for detecting electro-magnetic (EM) radiation in a broad spectral range, and are suitable for detecting extreme temperatures using spectroscopic methods described hereinabove. To enhance the operation of the sensor to attain several orders of magnitude detection range, various approaches can be used including, for example, using a multi-layer sensor as shown and described with respect to FIGS. 16A, 16B, 16C, and 16D; using acoustically enhanced detection; using a feedback system as shown in FIG. 13; using various signal processing techniques; performing neural network based signal processing, and the like.

Referring to FIG. 16A, a perspective pictorial and block diagram illustrates an embodiment of a sensor 1600A configured for detection or imaging of broadband electromagnetic radiation with increased sensitivity compare to a single layer. Two piezoelectric layers 1606 are sandwiched between conductive layers 1610. One of the outer conductive layers facing the EM radiation 1622 is coated with a wide-band EM absorbing layer 1608, such as a carbon coating or a black paint. Presence of the EM radiation produces a signal that is then sent to the amplifier 1620.

In another embodiment, the two piezoelectric layers 1606 have polarization orientation in opposite directions from each other. For example, each piezoelectric layer may have polarization normal to the electrode plane, however one oriented in +z direction, and the other −z direction.

Yet in another embodiment, the two piezoelectric layers 1606 have polarization orientations in the same direction.

Referring to FIG. 16B, a perspective pictorial and block diagram illustrates an embodiment of a sensor 1600B configured for detection or imaging of broadband electromagnetic radiation. Two piezoelectric layers 1606 are sandwiched between conductive layers 1610. One side of the device is coated with a wide-band EM absorbing layer 1608, such as a carbon coating or a black paint. Presence of the EM radiation produces a signal that is then sent to the amplifier 1620.

In another embodiment, an intermediate layer, such as another material, e.g. a metal layer, may be added to the edge of the sensor, and coat a wide-band EM absorbing layer 1608 on top of this layer.

In another embodiment, the two piezoelectric layers 1606 have polarization orientation in opposite directions from each other. For example, each piezoelectric layer may have polarization normal to the electrode plane, however one oriented in +z direction, and the other −z direction.

Yet in another embodiment, the two piezoelectric layers 1606 have polarization orientations in the same direction.

Referring to FIG. 16C, a perspective pictorial and block diagram illustrates an embodiment of a sensor 1600C configured for detection or imaging of broadband electromagnetic radiation with increased sensitivity compare to a single layer. Multiple piezoelectric layers 1606 are sandwiched between conductive layers 1610. One of the outer conductive facing the EM radiation 1622 is coated with a wide-band EM absorbing layer 1608, such as a carbon coating or a black paint. In the embodiment depicted in FIG. 16C, the multiple piezoelectric layers 1606 have polarization direction at alternating orientation. The conductive layers are also connected to each other at alternating scheme. Presence of the EM radiation produces a signal that is then sent to the amplifier 1620.

In another embodiment similar to FIG. 16C, the multiple piezoelectric layers 1606 have polarization direction in the same direction. In this case, only the first and the last layer conductors are connected to the amplifier.

Yet in another embodiment similar to FIG. 16C, the EM absorbing material can be coated on the side of the device in the y-z plane instead of the x-y plane, and the incident radiation is incident on this absorbing layer.

Referring to FIG. 16D, a perspective pictorial and block diagram illustrates an embodiment of a sensor 1600D configured for detection or imaging of broadband electromagnetic radiation. Two piezoelectric layers 1606 are sandwiched between conductive layers 1610. All or portion of one of the outer conductive layers facing the EM radiation 1622 is coated with a wide-band EM absorbing layer 1608, such as a carbon coating or a black paint. This embodiment is a bending structure. One side of the piezoelectric/ conductor layer stack is attached to a base. Presence of the EM radiation produces a signal that is then sent to the amplifier 1620.

In another embodiment similar to FIG. 16D, the two piezoelectric layers 1606 have polarization orientation in opposite directions from each other. For example, each piezoelectric layer may have polarization normal to the electrode plane, however one oriented in +z direction, and the other −z direction.

Yet in another embodiment similar to FIG. 16D, the two piezoelectric layers 1606 have polarization orientations in the same direction.

In yet another embodiment similar to FIG. 16D, the double layer structure comprising two piezoelectric layers 1606 and four conductive layers 1610 can be replaced with a multi-layer structure similar to FIG. 16C, with piezoelectric layers have polarization direction at alternating orientation, and electrodes connected in alternating fashion similar to FIG. 16C.

Yet in another embodiment similar to FIG. 16D, the double layer structure consisting of two piezoelectric layers 2906 and four conductive layers 1610 can be replaced with a multi-layer structure similar to FIG. 16D, with piezoelectric layers have polarization at the same direction. In this case, only the first and the last layer conductors are connected to the amplifier.

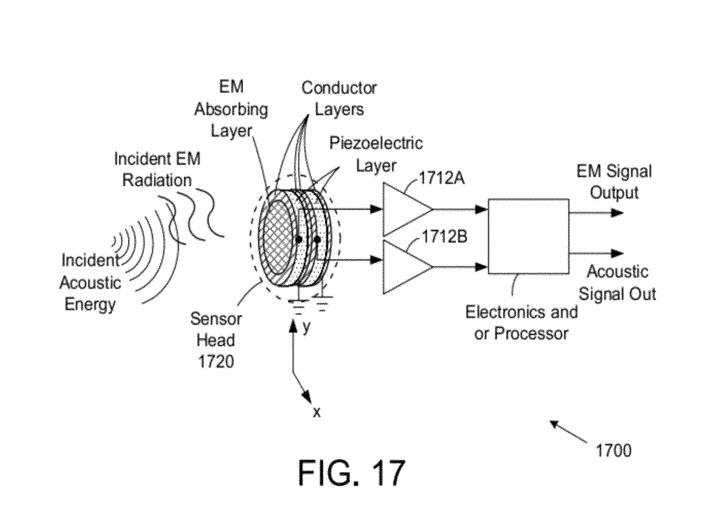

In some embodiments, a sensing device can perform acoustically enhanced detection. The detection range of the broadband sensors can be enhanced acoustically using various device configurations and techniques. Acoustical enhancement can be used by several methods, such as by using an external acoustic source similar to FIG. 17; using an electrical oscillating signal fed to the electrode piezoelectric elements to resonate the sensor; using electrical switching; and the like. Electrical switching techniques can include grounding the sensor or other electrical switching scheme. The electrical switching can induce the sensor element to resonate, for example by setting the switching frequency to the acoustic resonance of the sensor.

Referring to FIG. 17, a perspective pictorial and block diagram illustrates an embodiment of a sensor 1700 configured for single element, one-dimensional or two-dimensional photo-acoustic imaging of broadband electromagnetic radiation. The sensor elements described throughout the disclosure can be used such that two identical sensors are placed at close proximity, or on the same substrate. The apparatus has a single sensor element 1720. The sensor element 1720 can be used such that two identical sensors are placed at close proximity, or on the same substrate. EM radiation illuminates the element 1720. Illumination of the sensor element 1720 can be achieved by any known techniques such as using irises and radiation blocking material, or using imaging optics to focus only on the sensor head. The signal of the sensor can be amplified using amplifiers 1712A and 1712B, filtered if desired using a low-pass, band-pass or high-pass filters, and fed into a differential amplifier 1712. The function of the differential amplifiers 1712A-B can be also achieved using digital electronics, where the signal either directly from the sensor heads 1720, or the amplified signals can be converted to a digital signal using analog-to-digital converter or a data acquisition system and the signal is subtracted either using digital electronics or using computer software if the digital data is fed into a computer.

When the sensor is set to an acoustic or mechanical resonant condition, or any other acoustical vibration mode, then incident EM radiation alters the resonance conditions and vibration mode of the sensor. The output signal from the amplifier following the sensor contains both EM radiation signal and the acoustic signal. Using various filtering and correlation methods the acoustic and EM radiation effects can be separated.

Detectivity of the sensor is thus enhanced by selecting particular resonance frequency of the device, or a acoustical mode that is most sensitive to any changes induced by the incident EM radiation.

Accordingly, in some embodiments the apparatus 100 can be further comprise an acoustic enhancement device configured to form an acoustic or mechanical resonant condition of the at least one piezoelectric layer wherein electromagnetic radiation incident on the at least one piezoelectric layer modulates the resonance conditions and vibration mode of the sensor to generate a signal containing an electromagnetic radiation component and an acoustic component that can be separated by filtering and/or correlation techniques.

In various embodiments and/or conditions, a sensing apparatus can be configured to execute selected computation techniques for high-resolution image estimation. Examples of computational methods can include linear algebra, matrix inversion, eigenvalues and eigenvectors, and various matrix factorization and inversion techniques described in a linear algebra textbook, such as is described in G. Strang, Linear Algebra and Its Applications, 3^{rd} ed., Harcourt, Brace, Janovich, (San Diego, Calif. 1988). Other techniques can include neural network schemes. Using such techniques, the network can be trained with known amplitude and time-delay parameters, and the signal produced by the network can be a high-resolution image from coarse sensor data.

Accordingly, in some embodiments a sensing apparatus 100 can be configured wherein the controller 104 is configured to use linear algebra, matrix inversion, eigenvalue and eigenvector computations to estimate high-resolution images from coarse sensor data. Similarly, the sensing apparatus can be formed such that the controller is configured to reconstruct a high-resolution image using at least one calculation of a group consisting of linear algebra, matrix calculations, matrix inversions, matrix factorization, eigenvalue and eigenvector calculations, neural computing, morphological signal and image processing, spatial filtering, Fourier transformation, signal processing, and image processing.

Furthermore, in selected embodiments and/or conditions, the sensing apparatus 100 can be configured wherein the controller 104 is configured to use neural network based computations to estimate high-resolution images from coarse sensor data.

In some embodiments and/or conditions, a sensing device can execute signal processing and feedback techniques to improve detection. Several methods can be used to reduce noise and increase detection using signal processing. Another approach can use artificial neural network to increase detection response. Examples of neural network (NN) training include training a multi-sensor array to search for a particular type of pattern, training the NN to can find a signal buried in noise or find signal in high noise environment, training the NN to can adjust the sensor gain to the proper value, and the like.

Accordingly, in some embodiments the apparatus 100 can further comprise a feedback device coupled to the controller and configured to adjust to a predetermined detection range and independently control gain for individual pixels of the plurality of pixels wherein the individual pixels produce signals above a noise threshold and below a signal saturation level.

In various embodiments, the neural network can be implemented in software, or in hardware, such as in electrical circuit, in optical or opto-electronic device or system, or in a combination of technologies.

Hence, in some embodiments the apparatus 100 can further comprise a neural network training device coupled to the controller and configured to increase detection response by training using a technique selected from a group consisting of training a multiple sensor array to search for a specified type of pattern, training to detect a signal obscured by noise, training to detect a signal in a high noise environment, and training to adjust sensor gain to a selected value.

Referring to FIG. 13, the sensing system can further comprise a feedback connection to adjust sensing to a selected proper detection range. For example, a feedback command can be sent to an electronically adjustable gain amplifier, for example using electronically-controlled potentiometers as the gain control resistor of the amplifier. When the incident signal is too small, the amplifier gain is increased. For an excessive incident signal, the amplifier gain is decreased. In predetermined conditions, when the signal from one sensor element is too small, while the signal from another element is too large, the gain can be independently controlled for each element via feedback, such that both elements produce signals above the noise threshold, but are not too high to avoid signal saturation. Thus for a multi-element sensor, individual element feedback and control can be coupled to signal processing and/or neural network to attain a large dynamic range. Furthermore feedback can be combined with sensor calibration to achieve linearity over a large dynamic range.

Accordingly, in some embodiments the apparatus 100 can further comprise a sensor calibration device coupled to the controller and configured to attain linearity over a predetermined large dynamic range.

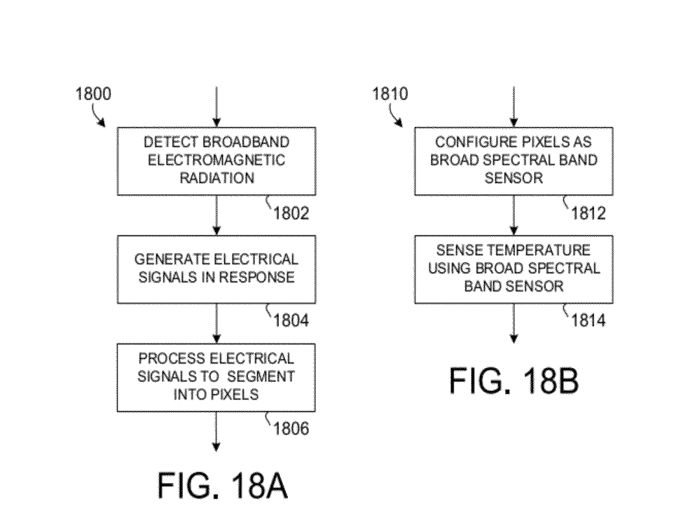

Referring to FIGS. 18A and 18B, schematic flow charts show an embodiment or embodiments of a method for a broad spectral imaging sensor that enables reduction of sensing electrodes. Referring to FIG. 18A, a sensing method 1800 can comprise detecting 1802 broadband electromagnetic (EM) radiation, and generating 1804 electrical signals in response to the detected broadband EM radiation. The method 1800 can further comprise processing 1806 the electrical signals to segment the sensor into a plurality of digitized pixels.

As shown in FIG. 18B, a sensing method 1810 can further comprise configuring 1812 the plurality of digitized pixels as a multiple-element broad-spectral band sensor operable to detect from ultraviolet to far infrared. Temperature can be sensed 1814 using the broad spectral band sensor.

In another embodiment similar to FIG. 18B, a sensing method 1810 can further comprise configuring 1812 the plurality of individually amplified and digitized pixels as a multiple-element broad-spectral band sensor operable to detect from wavelength of 0.35 nm, to wavelength 30 microns. Temperature can be sensed 1814 using the broad spectral band sensor.

The illustrative systems, sensors, and techniques include various aspects of operation including imaging by comparing signal from neighboring pixels, distance measurement and image mapping by time delay measurements, distance measurement and image mapping by frequency response measurements, distance and intensity measurements and image mapping by comparing data from various pixels data, use of triangulation or trilateration to map incident photons, and image estimation by matching estimated patterns from various pixel data.

Another aspect of operation can include high resolution imaging using coarse resolution pixels. The high resolution imaging can be performed using various techniques such as time delay measurements, frequency response measurements, cross-talk measurements, and the like. High resolution imaging can be executed using any combination of time delay measurement, frequency response measurement, cross-talk measurement, or the like.

Further aspects of imaging operation can include various methods of modulation methods for time delay, frequency response or amplitude measurements using modulation. Suitable modulation techniques can include mechanical choppers modulation, liquid crystal light modulation, electro-optic light modulation, electrical switching, electronic switching, electro-optic switching, source modulation, and the like. Other modulation methods can combine one or more modulation schemes.

Still additional aspects of imaging operation can include a broad spectral band sensor coupled with a spectrometer, temperature sensing using broad spectral band sensor, acoustically enhanced detection using broadband sensor, use of feedback system to increase dynamic range and reduce noise, use of neural network based processing to increase detection range, use of sensor calibration to achieve large linear dynamic range, and the like.

In various embodiments and/or in selected applications, the sensing apparatus can be configured to obtain high-resolution images from coarse detector arrays using one or more of various analyses such as amplitude decay, time delay, frequency modulation, or any combination of analysis.

In some embodiments, the sensing apparatus can perform high-resolution image reconstruction by trilateration or triangulation.

In still further embodiments, the sensing apparatus can be formed such that the sensor and controller are configured to perform imaging of at least one of the electro-magnetic spectral bands selected from a group consisting of ultra-violet (UV), visible, infrared (IR) a terahertz (THz), and microwave or millimeter wave radiation.

Furthermore, in various embodiments and/or conditions, the sensing apparatus can be constructed wherein the sensor and controller are configured to perform hyper-spectral and multi-spectral imaging.

In some embodiments and/or in selected applications, the sensing apparatus can be configured to perform high-resolution image reconstruction using one or more of several calculations or computations or combinations of computations selected from, for example, linear algebra, matrix calculations, matrix inversions, matrix factorization, eigenvalue and eigenvector calculations, neural computing, morphological signal and image processing, spatial filtering, fourier transformation, other signal and image processing methods, and the like.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. An apparatus comprising:
a sensor configured to detect broadband electromagnetic (EM) radiation and generate electrical signals in response to the detected broadband EM radiation; and
a controller coupled to the sensor configured to receive the electrical signals and process the electrical signals to segment the sensor response to broadband EM radiation into a plurality of digitized pixels.

2. The apparatus according to claim 1 wherein the sensor comprises:
at least one piezoelectric layer;
at least one absorbing layer coupled to the piezoelectric layer configured to detect broadband electromagnetic (EM) radiation; and
a plurality of electrodes coupled to the piezoelectric layer configured to generate electrical signals in response to the detected broadband EM radiation.

3. The apparatus according to claim 1 wherein:
the controller is configured to generate an image by comparing signals from at least two pixels of the plurality of pixels.

4. The apparatus according to claim 1 wherein:
the controller is configured to generate an image by comparing signals from neighboring pixels of the plurality of pixels.

5. The apparatus according to claim 1 wherein:
the controller is configured to perform time delay measurements on signals from the plurality of pixels and use the time delay measurements to determine distance measurements and perform image mapping.

6. The apparatus according to claim 1 wherein:
the controller is configured to perform frequency response measurements on signals from the plurality of pixels and use the frequency response measurements to determine distance measurements and perform image mapping.

7. The apparatus according to claim 1 wherein:
the controller is configured to compare signals from selected pixels of the plurality of pixels and use the compared signals to perform distance and intensity measurements and perform image mapping.

8. The apparatus according to claim 1 wherein:
the controller is configured to map incident photons using triangulation or trilateration.

9. The apparatus according to claim 1 wherein:
the controller is configured to match patterns from signals of selected ones of the plurality of pixels and perform image estimation according to the matched patterns.

10. The apparatus according to claim 1 wherein:
the controller is configured to perform high resolution imaging using coarse resolution pixels.

11. The apparatus according to claim 1 wherein:
the controller is configured to perform high resolution imaging using coarse resolution pixels comprising at least one measurement selected from a group consisting of time delay measurement, frequency response measurement, and cross-talk measurement.

12. The apparatus according to claim 1 wherein:
the controller is configured to perform imaging using at least one measurement selected from a group consisting of time delay measurement, frequency response measurement, amplitude measurement, and cross-talk measurement, wherein:
the selected at least one measurement comprises a modulation method selected from a group consisting of mechanical choppers modulation, liquid crystal light modulation, an electro-optic light modulator, electrical switching, electronic switching, electro-optic switching, and source modulation.

13. The apparatus according to claim 1 further comprising:
a spectrometer configured to reflect incident electromagnetic radiation to the sensor.

14. The apparatus according to claim 1 wherein:
the apparatus is configured as a multiple-element broad-spectral band sensor operable to detect from ultraviolet to far infrared; and
the controller is configured to sense temperature using the broad spectral band sensor.

15. The apparatus according to claim 1 further comprising:
an acoustic enhancement device configured to form an acoustic or mechanical resonant condition of the sensor wherein electromagnetic radiation incident on the sensor modulates the resonance conditions and vibration mode of the sensor to generate a signal containing an electromagnetic radiation component and an acoustic component that can be separated by filtering and/or correlation techniques.

16. The apparatus according to claim 1 further comprising:
a feedback device coupled to the controller and configured to adjust to a predetermined detection range and independently control gain for individual pixels of the plurality of pixels wherein the individual pixels produce signals above a noise threshold and below a signal saturation level.

17. The apparatus according to claim 1 further comprising:
a sensor calibration device coupled to the controller and configured to attain linearity over a predetermined large dynamic range.

18. The apparatus according to claim 1 further comprising:
a neural network training device coupled to the controller and configured to increase detection response by training using a technique selected from a group consisting of training a multiple sensor array to search for a specified type of pattern, training to detect a signal obscured by noise, training to detect a signal in a high noise environment, and training to adjust sensor gain to a selected value.

19. The apparatus according to claim 1 wherein:
the controller is configured to use linear algebra, matrix inversion, eigenvalue and eigenvector computations to estimate high-resolution images from coarse sensor data.

20. The apparatus according to claim 1 wherein:
the controller is configured to use neural network based computations to estimate high-resolution images from coarse sensor data.

21. The apparatus according to claim 1 wherein:
the controller is configured to reconstruct a high-resolution image by trilateration or triangulation.

22. The apparatus according to claim 1 wherein:
the controller is configured to reconstruct a high-resolution image using at least one calculation of a group consisting of linear algebra, matrix calculations, matrix inversions, matrix factorization, eigenvalue and eigenvector calculations, neural computing, morphological signal and image processing, spatial filtering, Fourier transformation, signal processing, and image processing.

23. The apparatus according to claim 1 wherein the sensor comprises:
at least one of a group consisting of a capacitive layer, a microelectromechanical system, a pyroelectric layer, a bolometer, and a microbolometer.

24. The apparatus according to claim 1 wherein the sensor comprises:
at least one thermally conductive layer.

25. The apparatus according to claim 1 wherein:
the sensor and controller are configured to perform amplitude detection for locating at least one illumination detection selected from a group consisting of a laser beam spot, ultra-violet (UV), visible, infrared (IR) illumination spot, a terahertz (THz), and microwave or millimeter wave illumination spot.

26. The apparatus according to claim 1 wherein:
the sensor and controller are configured to perform imaging of at least one of the electro-magnetic spectral bands selected from a group consisting of ultra-violet (UV), visible, infrared (IR) a terahertz (THz), and microwave or millimeter wave radiation.

27. The apparatus according to claim 1 wherein:
the sensor and controller are configured to perform hyper-spectral and multi-spectral imaging.

28. An apparatus comprising:
a controller configured to obtain high-resolution imaging from a coarse detector array using one or more information items including time delay.

29. The apparatus according to claim 28 wherein:
the controller is configured to obtain high-resolution imaging from a coarse detector array using time delay in combination with at least one of amplitude decay and frequency modulation.

30. The apparatus according to claim 28 wherein:
the controller is configured to reconstruct a high-resolution image by trilateration or triangulation.

31. The apparatus according to claim 28 wherein:
the controller is configured to reconstruct a high-resolution image using at least one calculation of a group consisting of linear algebra, matrix calculations, matrix inversions, matrix factorization, eigenvalue and eigenvector calculations, neural computing, morphological signal and image processing, spatial filtering, Fourier transformation, signal processing, and image processing.

32. The apparatus according to claim 28 wherein the sensor comprises:
at least one of a group consisting of a capacitive layer, a microelectromechanical system, a pyroelectric layer, a bolometer, and a microbolometer.

33. The apparatus according to claim 28 wherein the sensor comprises:
at least one thermally conductive layer.

34. The apparatus according to claim 28 wherein:
the sensor and controller are configured to perform imaging of at least one of the electro-magnetic spectral bands selected from a group consisting of ultra-violet (UV), visible, infrared (IR) a terahertz (THz), and microwave or millimeter wave radiation.

35. The apparatus according to claim 28 wherein:
the sensor and controller are configured to perform hyper-spectral and multi-spectral imaging.
